(19) United States
(12) Patent Application Publication
(10) Pub. No.: US 2007/0298193 A1
(43) Pub. Date: Dec. 27, 2007

(54) Method of Producing Light-Scattering Film, Polarizing Plate Comprising Light-Scattering Film and Liquid Crystal Display Device Comprising the Polarizing Plate

(76) Inventors: Kazuhiro Nakamura, Minami-Ashigara-shi (JP); Katsumi Inoue, Minami-Ashigara-shi (JP)

Correspondence Address: BUCHANAN, INGERSOLL & ROONEY PC, POST OFFICE BOX 1404, ALEXANDRIA, VA, 22313-1404, US

(21) Appl. No.: 11/660,160

(22) PCT Filed: Sep. 13, 2005
(86) PCT No.: PCT/JP05/17242

§ 371 Date: Feb. 14, 2007

(30) Foreign Application Priority Data
Sep. 16, 2004 (JP) 2004-269886

(51) Int. Cl. G02B 5/30

(52) U.S. Cl. 428/1.33; 427/163.4

(57) ABSTRACT

A method of producing a light-scattering film, comprising: disposing a land of a forward end lip of a slot die close to a surface of a web; and applying a coating composition on the web through a slot of the forward end lip, so as to provide the coating composition directly or indirectly on the transparent support, wherein the web is being continuously running while being supported on a backup roll, and wherein the coating composition comprises a light-transmitting particulate material, a transmitting resin and a solvent, and the coating composition satisfies relationship (1) in order to control a sedimentation rate of the light-transmitting particulate material:
(σ−ρ)×d²≦1.5 (1)
wherein σ represents a density of the light-transmitting particulate material (g/cm²); ρ represents a density of the coating composition (g/cm²); and d represents an average particle diameter of the light-transmitting particulate material (μm).

### TECHNICAL FIELD

The present invention relates to a method of producing a light-scattering film and more particularly to a method of producing a light-scattering film having uniform in-plane scattering properties which comprises spreading a coating composition having controlled sedimentation of light-transmitting particulate material using a die coater to realize a high productivity. The present invention also relates to a polarizing plate comprising the light-scattering film and a liquid crystal display device comprising the polarizing plate.

### BACKGROUND ART

Light-scattering films can be roughly divided into surface-scattering anti-glare film and internal-scattering film having scattering properties only in its interior thereof. An anti-glare film is normally disposed on the outermost surface of a display device such as CRT, plasma display (PDP), electroluminescence display (ELD) and liquid crystal display device (LCD) to prevent the reflection of image due to reflection of external light rays. Further, with the recent trend for enhancement of precision of display devices, a technique concerning anti-glare films having internal scattering properties in addition to surface scattering properties has been disclosed as a means for eliminating minute brightness unevenness (called glittering) due to anti-glare film (JP-A-2000-304648, Japanese Patent No. 3507719, JP-A-11-3276608, Japanese Patent No. 3515401 and Japanese Patent No. 3515426).

On the other hand, a technique concerning a light-scattering film which has no surface scattering properties but internal scattering properties to improve the viewing angle properties of LCD (JP-A-2003-121606). As disclosed in JP-A-2003-121606 and JP-A-2003-270409, it is known that in the case where a light-scattering film is disposed on the outermost surface of a display device, a film which has an effect of inhibiting the surface reflection of external light rays in the daylight to exhibit anti-reflection properties as well is preferably used.

The aforementioned light-scattering film has been heretofore produced by a bar coating method, gravure method, microgravure method or the like. In recent years, techniques concerning die coating method that can be preferably used in a region where the wet spread is relatively small have been disclosed in JP-A-2003-236434, etc.

However, the coating compositions for light-scattering layer disclosed in the above cited patent references are disadvantageous in that there occurs unevenness in the plane of the light-scattering film attributed to accumulation of light-transmitting particulate material in the pocket in the die coater or crosswise ununiformity of density of light-transmitting particulate material in the coating composition ejected from the slot during the spreading by the die coating method. It has been a difficult assignment to solve these problems.

### DISCLOSURE OF THE INVENTION

As mentioned above, no method of producing a light-scattering film having uniform in-plane scattering properties using a die coating method that attains a high productivity has been proposed.

It is therefore an aim of the invention to provide a light-scattering film and an anti-reflection film having uniform in-plane scattering properties at a high productivity.

The inventors made extensive studies of solution to the aforementioned problems. As a result, an idea was reached that the aforementioned problems are attributed to too high a sedimentation rate of light-transmitting particulate material. It has thus been found that the aforementioned problems can be solved to accomplish the aim of the invention by adjusting the sedimentation rate of the light-transmitting particulate material in the coating composition focusing on factors, i.e., density of the light-transmitting particulate material, density of the coating composition and average particle diameter of the light-transmitting particulate material. The invention has been thus worked out.

In other words, the aforementioned aim of the invention is accomplished by the following constitutions.

(1) A method of producing a light-scattering film comprising a light-scattering layer provided directly or indirectly on a transparent support, the method comprising:

disposing a land of a forward end lip of a slot die close to a surface of a web; and

applying a coating composition for the light-scattering layer on the web through a slot of the forward end lip, so as to provide the coating composition for the light-scattering layer directly or indirectly on the transparent support,

wherein the web is being continuously running while being supported on a backup roll, and

wherein the coating composition comprises a light-transmitting particulate material, a transmitting resin and a solvent, and the coating composition satisfies relationship (1) in order to control a sedimentation rate of the light-transmitting particulate material:
(σ−ρ)×d²≦1.5 (1)

wherein σ represents a density of the light-transmitting particulate material (g/cm²);

ρ represents a density of the coating composition (g/cm²); and

d represents an average particle diameter of the light-transmitting particulate material (μm).

(2) The method of producing a light-scattering film as described in (1) above,

wherein the light-transmitting particulate material in the coating composition swells with the solvent to allow σ, ρ and d after swelling to satisfy the relationship (1).

(3) The method of producing a light-scattering film as described in (1) or (2) above,

wherein an average particle diameter of the light-transmitting particulate material is from 0.5 μm to 5 μm, a difference in refractive index between the light-transmitting particulate material and the light-transmitting resin is from 0.01 to 0.2 and an amount of the light-transmitting particulate material in the light-scattering layer is from 3 to 30% by mass based on a total solid content in the light-scattering layer.

(4) The method of producing a light-scattering film as described in any of (1) to (3) above,

wherein the light-transmitting particulate material is a crosslinked polystyrene, a crosslinked poly(acryl-styrene), a crosslinked poly((meth)acrylate) or a mixture thereof, and the solvent comprises at least one solvent selected from the group consisting of a ketone, toluene, xylene and an ester.

(5) The method of producing a light-scattering film as described in any of (1) to (4) above,

wherein the light-scattering film is an anti-reflection film comprising a low refractive layer having a lower refractive index than a refractive index of the transparent support, and the low refractive layer is formed directly on the light-scattering layer or on a layer(s) provided on the light-scattering layer.

(6) The method of producing a light-scattering film as described in any of (1) to (5) above, which further comprises applying a coating composition for the low refractive layer or a coating composition for an other layer on the web by utilizing a slot die having an overbite form,

wherein the slot die comprises a downstream lip having a land length of not smaller than 30 μm to not greater than 100 μm and an upstream lip, and

wherein a gap between the downstream lip and the web is smaller than a gap between the upstream lip and the web by from not smaller than 30 μm to not greater than 120 μm when the slot die is disposed at a coating position.

(7) A polarizing plate comprising:

a polarizing film; and

two sheets of protective films, and each one of the protective films is laminated on a front surface or a back surface of the polarizing film respectively, for protecting both the front surface and the back surface of the polarizing film, wherein a light-scattering film produced by a method as described in any of (1) to (6) above is utilized as one of the protective films.

(8) The polarizing plate as described in (7) above,

wherein a film other than the light-scattering film among the two sheets of the protective films constituting the polarizing plate is an optical compensation film comprising an optical compensation layer containing an optically anisotropic layer provided on a side opposite to a side on which the film is laminated on the polarizing film, the optically anisotropic layer is a layer comprising a compound having a discotic structure unit, a disc surface of the discotic structure unit is disposed obliquely to a surface of the protective film and an angle of the disc surface of the discotic structure unit with respect to the surface of the protective film changes in a depth direction of the optically anisotropic layer.

(9) An image display device comprising a light-scattering film produced by a method as described in any of (1) to (6) above.

(10) A liquid crystal display device comprising at least one of a light-scattering film produced by a method as described in any of (1) to (6) above and a polarizing plate as described in (7) or (8) above.

(11) A liquid crystal display device comprising:

a liquid crystal cell;

a polarizer provided on both sides of the liquid crystal cell;

at least one sheet of a phase difference compensating element provided between the liquid crystal cell and the polarizer; and

a light-scattering film produced by a method as described in any of (1) to (6) above provided on a surface of the liquid crystal display device.

### BRIEF DESCRIPTION OF THE DRAWING

FIG. 1 is a sectional view diagrammatically illustrating a preferred embodiment of the light-scattering film of the invention (layer configuration of anti-reflection film);

FIG. 2 is a sectional view of a coater 10 comprising a slot die 13 embodying the invention;

FIG. 3A illustrates a sectional shape of the slot die 13 of the invention and FIG. 3B illustrates a sectional shape of a related art slot die 30;

FIG. 4 is a perspective view illustrating a slot die 13 to be used at a coating step embodying the invention and its periphery;

FIG. 5 is a sectional view illustrating a pressure reducing chamber 40 and a web W which are disposed close to each other (back plate 40a is formed integrally with the main body of the chamber 40); and

FIG. 6 is the same as FIG. 5 (back plate 40a is fixed to the chamber 40 with a screw 40c),

wherein 1 denotes light-scattering film (anti-reflection film); 2 denotes transparent support; 3 denotes light-scattering layer; 4 denotes low refractive layer; 5 denotes light-transmitting particulate material; 10 denotes coater; 11 denotes backup roll; W denotes web; 13 denotes slot die; 14 denotes coating solution; 14a denotes bead; 14b denotes coating layer; 15 denotes pocket; 16 denotes slot; 17 denotes forward end lip; 18 denotes land; 18a denotes upstream lip land; 18b denotes downstream lip land; I_{UP} denotes length of upstream lip land 18a; I_{LO} denotes length of downstream lip land 18b; LO denotes overbite length (difference between the distance of the downstream lip land 18b from the web W and the distance of the upstream lip land 18a from the web W); G_{L} denotes gap between forward end lip 17 and web W (gap between downstream lip land 18b and web W); 30 denotes Related art slot die; 31a denotes upstream lip land; 31b denotes downstream lip land; 32 denotes pocket; 33 denotes slot; 40 denotes pressure reducing chamber; 40a denotes back plate; 40b denotes side plate; 40c denotes screw; G_{B} denotes Gap between back plate 40a and web W; and G_{S} denotes Gap between side plate 40b and web W.

### BEST MODE FOR CARRYING OUT THE INVENTION

The invention will be further described hereinafter. In the present specification, in the case where the numerical values indicate physical values, properties or the like, the term “(value 1) to (value 2)” as used herein is meant to indicate “not smaller than (value 1) to not greater than (value 2)”. The term “(meth)acrylate” as used herein is meant to indicate “at least any of acrylate and methacrylate”. This applies also to “(meth)acrylic acid”.

The basic configuration of a preferred embodiment of the light-scattering film of the invention will be described hereinafter in connection with the attached drawings.

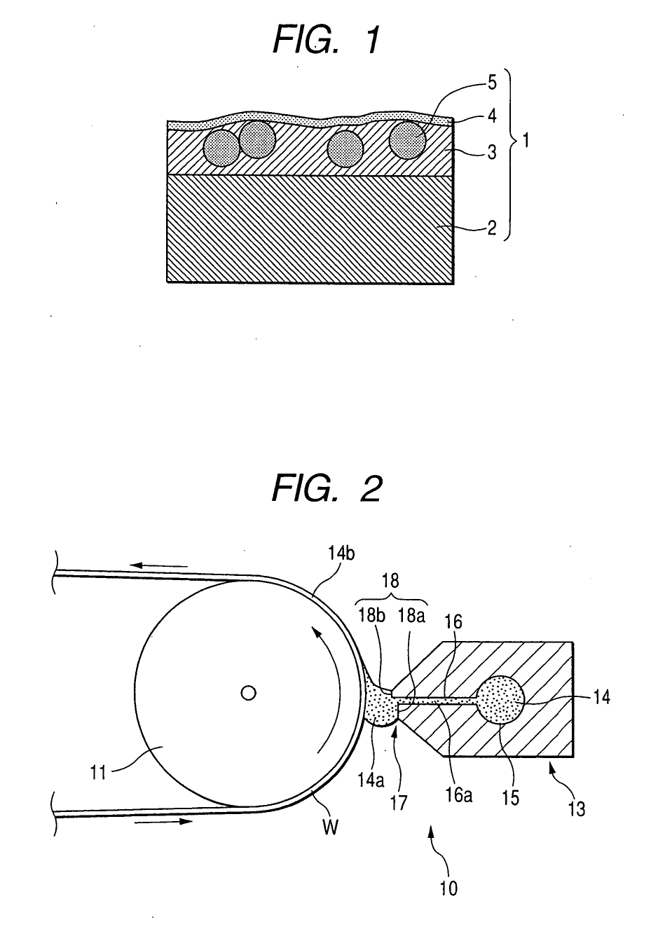

FIG. 1 is a sectional view diagrammatically illustrating a preferred embodiment of the light-scattering film of the invention. FIG. 1 illustrates an example of the anti-glare light-scattering film of the invention having a surface roughness. However, a light-scattering film having neither surface roughness nor anti-glare properties, too, is preferably used.

The light-scattering film 1 according to the present embodiment shown in FIG. 1 comprises a transparent support 2, a light-scattering layer 3 formed on the transparent support 2 and a low refractive layer 4 formed on the light-scattering layer 3. By forming a low refractive layer on the light-scattering layer to a thickness of about ¼ of the wavelength of light, the surface reflection can be eliminated by the principle of thin layer interference to further advantage.

The light-scattering layer 3 comprises a light-transmitting resin and a light-transmitting particulate material 5 dispersed in the light-transmitting resin.

The refractive index of the various layers constituting the light-scattering film comprising an anti-reflection layer of the invention preferably satisfy the following relationship.
Refractive index of light-scattering layer>refractive index of transparent support>refractive index of low refractive layer

In the invention, the light-scattering layer has ant-glare properties and/or hard coat properties and is shown composed of one layer in the present embodiment. However, the light-scattering layer may be composed of a plurality of layers, e.g., two to four layers. The light-scattering film layer may be provided directly on the transparent support as in the present embodiment but may be provided on the transparent support with other layers such as antistatic layer and moistureproof layer interposed therebetween.

In order to provide the light-scattering film of the invention with anti-glare properties, the surface roughness of the light-scattering film of the invention is preferably designed such that the central line-average roughness Ra is from 0.08 to 0.40 μm, the ten point-average roughness Rz is 10 times or less Ra, the average mountain-valley distance Sm is from 1 to 100 μm, the standard deviation of height of raised portions from the deepest valley of roughness is 0.5 μm or less, the standard deviation of average mountain-valley distance Sm with central line as reference is 20 μm or less and the proportion of surfaces having an inclination angle of from 0 to 5 degrees is 10% or more to attain sufficient anti-glare properties and visually uniform matte look to advantage.

Further, it is preferred that the tint of reflected light in CIE1976L*a*b* color space under C light source comprise a* value of from −2 to 2 and b* value of from −3 to 3 and the ratio of minimum reflectance to maximum reflectance in the wavelength range of from 380 nm to 780 nm be from 0.5 to 0.99 to make the tint of reflected light neutral. Moreover, when b* value of transmitted light under C light source is from 0 to 3, the yellow tint of white display developed when the anti-reflection film is applied to display device is reduced to advantage. Further, the standard deviation of brightness distribution measured on the anti-reflection film with a lattice having a size of 120 μm×40 μm put interposed between a planer light source and the anti-reflection film is preferably 20 or less to eliminate glare developed when the anti-reflection film of the invention is applied to a high resolution panel.

On the other hand, the light-scattering film having only internal scattering properties of the invention preferably has a surface roughness such that the central line-average roughness Ra is 0.10 or less and thus exhibits substantially no anti-glare properties. The light-scattering film of the invention has a large number of regions having different refractive indexes present in the interior of the light-scattering layer to attain internal scattering properties. Further, the scattering properties of the light-scattering film of the invention is preferably optimized such that the viewing angle properties of the liquid crystal display device can be enhanced when the light-scattering film is disposed on the outermost surface thereof.

Further, the anti-reflection film having an anti-reflection layer of the invention preferably has optical properties such that the specular reflectance is 2.5% or less and the transmittance is 90% or more to inhibit the reflection of external light rays and hence improve the viewability. In order to inhibit the glare on high resolution LCD panel and eliminate blurring of letters, etc., the haze of the light-scattering film is preferably from 1% to 60%, more preferably from 20% to 60%, particularly from 20% to 50%, the ratio of internal haze to total haze be from 0.3 to 1, the drop from haze of the laminate up to the light-scattering film layer to haze developed after the formation of the low refractive layer be 15% or less, the sharpness of transmitted image at a comb width of 0.5 mm be from 10% to 70% and the ratio of transmittance of light transmitted at right angle to light transmitted obliquely at an angle of 2 degrees from the right angle be from 1.5 to 5.0. In the case where it is not desired to provide anti-glare properties, the sharpness of transmitted image is preferably from 65% to 99%.

The light-scattering layer will be further described hereinafter.

<Light-Scattering Layer>

The light-scattering layer is formed for the purpose of providing the film with light-scattering properties developed by surface scattering and/or internal scattering and hard coat properties for enhancing preferably the scratch resistance of the film. Accordingly, the light-scattering layer preferably comprises as essential components a light-transmitting resin capable of providing hard coat properties, a light-transmitting particulate material for providing light-scattering properties and a solvent. Further, the coating composition for light-scattering layer arranged such that the aforementioned relationship (1) can be satisfied to control the sedimentation rate of the light-transmitting particulate material can be spread over the transparent support with a high in-plane uniformity using a die coating method that attains a high productivity. The left side of the relationship (1) is a member concerning the density and particle diameter of light-transmitting particulate material and the density of coating composition in the equation (2) of sedimentation rate of particles in a fluid derived from Stockes' equation. When the value of this member is 1.5 or less, the aforementioned various troubles attributed to the fact that the sedimentation rate of the light-transmitting particulate material at the coating step involving die coating method is too high can be easily avoided. The value of this member is more preferably 1.0 or less, even more preferably 0.5 or less. In the case where the value of this member is negative, the light-transmitting particulate material is suspended when the elapse of a long period of time. However, this phenomenon causes no great problem when the coating composition is continuously fed. Nevertheless, the value of this member is preferably as close to zero as possible.

Other examples of the factor governing the sedimentation rate of light-transmitting particles include the viscosity of the coating composition. From the standpoint of sedimentation rate, the viscosity of the coating composition is preferably as great as possible. From the standpoint of adaptability to high speed coating, however, the viscosity of the coating composition is 20×10⁻³ (Pa·s) or less, particularly 15×10⁻³ (Pa·s) or less, more preferably 10×10⁻³ (Pa·s) or less. From the standpoint of prevention of drying unevenness, the viscosity of the coating composition is 1×10⁻³ (Pa·s) or more, particularly 3×10⁻³ (Pa·s) or more, more particularly 5×10⁻³ (Pa·s) or more. In order to control the sedimentating properties of particles while attaining both desired adaptability to high speed coating and desired resistance to drying unevenness, the viscosity of the coating composition is preferably from 3×10⁻³ to 15×10⁻³ (Pa·s), particularly from 5×10⁻³ to 10 10⁻³ (Pa·s).
Sedimentation rate Vs=( 1/18)×(σ−ρ)×(g/μ)×d² (2)
wherein σ represents the density of the light-transmitting particulate material (g/cm²); ρ represents the density of the coating composition (g/cm²); g represents acceleration of gravity; d represents the average particle diameter of the light-transmitting particulate material; and μ represents the viscosity of the coating composition (Pa·s).

In the coating composition for forming the light-scattering film of the invention, when the light-transmitting particulate material swells somewhat with the solvent, the density of the light-transmitting particulate material and the density of the coating composition are apparently close to each other to reduce the absolute value of the member (σ−ρ) in the equation (1) and hence the sedimentation (suspension) rate to advantage. Referring to combination that facilitates the swelling of the light-transmitting particulate material with the solvent, the light-transmitting particulate material is preferably made of a crosslinked polystyrene, crosslinked poly (acryl-styrene), crosslinked poly((meth)acrylate) or mixture thereof and the solvent is preferably at least one selected from the group consisting of ketones, toluene, xylene and esters. The swelling of the light-transmitting particulate material can be controlled also by the crosslink density of the light-transmitting particulate material or may be adjusted by selecting the kind of the solvent to be combined with the light-transmitting particulate material.

<Light-Transmitting Particulate Material>

The average particle diameter of the light-transmitting particulate material is preferably from 0.5 to 5 μm, more preferably from 1.0 to 4.0 μm. When the average particle diameter of the light-transmitting particulate material falls below 0.5 μm, the scattering angle of light is widely distributed, causing the drop of the letter resolution of display to disadvantage. On the contrary, when the average particle diameter of the light-transmitting particulate material exceeds 5 μm, the absolute value of the equation (1) becomes too large, raising problems such as rise of sedimentation rate and necessity of raising the thickness of the light-scattering layer resulting in the rise of curling and material cost.

Specific examples of the aforementioned light-transmitting particulate materials are not specifically limited so far as the resulting coating composition satisfies the relationship (1). Preferred examples of the light-transmitting particulate materials include inorganic particulate compounds such as particulate silica and particulate TiO₂, and particulate resins such as particulate poly((meth)acrylate), particulate crosslinked poly((meth)acrylate), particulate polystyrene, particulate crosslinked polystyrene, particulate crosslinked poly(acryl-styrene), particulate melamine resin and particulate benzoguanamine resin. However, inorganic particulate materials normally have a great specific gravity and thus are preferably not used. Particulate resins are preferably used. Preferred among these particulate resins are particulate crosslinked polystyrene, particulate crosslinked poly ((meth)acrylate) and particulate poly(acryl-styrene).

The shape of the light-transmitting particulate material is preferably sphere. An amorphous light-transmitting particulate material may be used. However, since the amorphous light-transmitting particulate material has a shape factor different from sphere in the sedimentation rate equation, the left side of the equation (1) differs with the shape of the light-transmitting particulate material.

Two or more light-transmitting particulate materials having different particle diameters may be used in combination. A light-transmitting particulate material having a greater particle diameter may be used to provide anti-glare properties while a light-transmitting particulate material having a smaller particle diameter may be used to provide other optical properties. For example, in the case where the anti-reflection film is stuck to a high resolution display having a precision of 133 ppi or more, it is required that no defects in optical properties called glittering as mentioned above occur. Glittering is attributed to the loss of uniformity in brightness by the expansion or shrinkage of pixels due to unevenness (contributing to anti-glare properties) present on the surface of the film. Glittering can be drastically eliminated by the additional use of a light-transmitting particulate material having a smaller particle diameter than that of the light-transmitting particulate material for providing anti-glare properties and a refractive index different from that of the binder.

The aforementioned light-transmitting particulate material is incorporated in the light-scattering layer thus formed in an amount of from 3 to 30% by mass, more preferably from 5 to 20% by mass based on the total solid content in the light-scattering layer. (In this specification, % by mass is equal to % by weight.) When the content of the light-transmitting particulate material falls below 3% by mass, the resulting light-scattering effect is insufficient. On the contrary, when the content of the light-transmitting particulate material exceeds 30% by mass, there arise problems such as drop of image resolution and surface turbidity and glittering.

The density of the light-transmitting particulate material is preferably from 10 to 1,000 mg/m², more preferably from 100 to 700 mg/m².

For the measurement of the distribution of particle size of light-transmitting particles, a coulter counter method is employed. The particle size distribution thus measured is then converted to distribution of number of particles.

The refractive index of the mixture of light-transmitting resin and light-transmitting particulate material of the invention is preferably from 1.48 to 2.00, more preferably from 1.50 to 1.80. In order to predetermine the refractive index of the mixture of light-transmitting resin and light-transmitting particulate material within the above defined range, the kind and proportion of the light-transmitting resin and light-transmitting particulate material may be properly selected. The method of selecting these factors can easily be previously known experimentally.

In the invention, the difference in refractive index between the light-transmitting resin and the light-transmitting particulate material (refractive index of light-transmitting particulate material—refractive index of light-transmitting resin) is preferably from 0.01 to 0.2, more preferably from 0.02 to 0.2, even more preferably from 0.05 to 0.15. When the difference falls below 0.02, the resulting internal scattering effect is insufficient, causing further glittering. On the contrary, when the difference exceeds 0.2, the film becomes cloudy to disadvantage.

The refractive index of the aforementioned light-transmitting resin is preferably from 1.45 to 2.00, more preferably from 1.48 to 1.60.

The refractive index of the aforementioned light-transmitting resin is preferably from 1.40 to 1.80, more preferably from 1.48 to 1.70.

The refractive index of the aforementioned light-transmitting resin can be directly measured by an Abbe's refractometer or quantitatively evaluated by measuring spectral reflection spectrum or spectral ellipsometry.

The thickness of the light-scattering layer is preferably from 1 to 10 μm, more preferably from 1.2 to 8 μm. When the thickness of the light-scattering layer is too small, the resulting light-scattering layer exhibits an insufficient hardness. On the contrary, when the thickness of the light-scattering layer is too great, the resulting light-scattering layer exhibits deteriorated curling or brittleness resistance and hence a deteriorated workability. Thus, the thickness of the light-scattering layer preferably falls within the above defined range.

<Light-Transmitting Resin>

The light-transmitting resin is preferably a binder polymer having a saturated hydrocarbon chain or polyether chain as a main chain, more preferably a binder polymer having a saturated hydrocarbon chain as a main chain. The binder polymer preferably ahs a crosslinked structure.

The binder polymer having a saturated hydrocarbon chain as a main chain is preferably a polymer of ethylenically unsaturated monomers. The binder polymer having a saturated hydrocarbon chain as a main chain and a crosslinked structure is preferably a (co)polymer of monomers having two or more ethylenically unsaturated groups.

In order to provide the binder polymer with a high refractive index, a high refractive monomer containing an aromatic ring or at least one atom selected from the group consisting of halogen atoms other than fluorine, sulfur atom, phosphorus atom and nitrogen atom in its structure may be selected.

Examples of the monomer having two or more ethylenically unsaturated groups include esters of polyvalent alcohol with (meth)acrylic acid [e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate], ethylene oxide modification products thereof, vinylbenzene and derivatives thereof [e.g., 1,4-divinylbenzene, 4-vinylenzoic acid-2-acryloylethylsulfone, 1,4-vinylcyclohexanone], vinylsulfone (e.g., divinylsulfone), acrylamide (e.g., methylene bisacrylamide), and methacrylamide. These monomers may be used in combination of two or more thereof.

Specific examples of the high refractive monomers include bis(4-methacryloylthiophenyl)sulfide, vinyl naphthalene, vinylphenyl sulfide, and 4-methacryloxyphenyl-4′-methoxyphenylthioether. These monomers may be used in combination of two or more thereof.

The polymerization of the monomers having an ethylenically unsaturated group may be carried out by the irradiation with ionizing radiation or heating in the presence of a photoradical polymerization initiator or heat radical polymerization initiator.

Accordingly, the aforementioned light-scattering layer can be formed by preparing a coating solution containing a light-transmitting resin-forming monomer such as the aforementioned ethylenically unsaturated monomer, a photoradical polymerization initiator or heat radical polymerization initiator, a light-transmitting particulate material and optionally an inorganic filler as described later, spreading the coating solution over a transparent support, and then irradiating the coating layer with ionizing radiation or heating the coating layer to undergo polymerization reaction that causes curing.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniniums. Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholino propiophenone, and 2-benzyl-2-dimethylamino-1-(4-moropholinophenyl-butanone. Examples of the benzoins include benzoinbenzenesulfonic acid ester, benzointoluenesulfonic acid ester, benzoin methyl ether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethylbenzoyl diphenyl phosphine oxide.

Various examples of the photoradical polymerization initiator are listed also in “Saishin UV Koka Gijutsu (Newest UV Curing Technique)”, TECHNICAL INFORMATION INSTITUTE CO., LTD., page 159, 1991. These examples are useful in the invention.

Preferred examples of commercially available photocleavable photoradical (polymerization) initiators include Irgacure (651, 184, 907) (produced by Nihon Ciba-Geigy K.K.).

The photoradical (polymerization) initiator is preferably used in an amount of from 0.1 to 15 parts by mass, more preferably from 1 to 10 parts by mass based on 100 parts by mass of polyfunctional monomer.

In addition to the photoradical (polymerization) initiator, a photosensitizer may be used. Specific examples of the photosensitizer include n-butylamine, triethylamine, tri-n-butylphosphine, Michler's ketone, and thioxanthone.

As the heat radical polymerization initiator there may be used an organic or inorganic peroxide, an organic azo or diazo compound or the like.

Specific examples of the organic peroxide include benzoyl peroxide, halogen benzoyl peroxide, lauroyl peroxide, acetyl peroxide, dibutyl peroxide, cumene hydroperoxide, and butyl hydroperoxide. Specific examples of the inorganic peroxide include hydrogen peroxide, ammonium persulfate, and potassium persulfate. Specific examples of the azo compound include 2-azo-bis-isobutylnitrile, 2-azo-bis-propionitrile, and 2-azo-bis-cyclohexanedinitrile. Specific examples of the diazo compound include diazoaminobenzene, and p-nitrobenzene diazonium.

The polymer having a polyether as a main chain is preferably a ring-opening polymerization product of a polyfunctional epoxy compound. The ring-opening polymerization of a polyfunctional epoxy compound may be effected by irradiation with ionizing radiation or heating in the presence of a photo-acid generator or heat-acid generator.

Accordingly, the light-scattering layer can be formed by preparing a coating solution containing a polyfunctional epoxy compound, a photo-acid generator or heat-acid generator, a light-transmitting particulate material and an inorganic filler, spreading the coating solution over a transparent support, and then irradiating the coating layer with ionizing radiation or heating the coating layer to undergo polymerization reaction that causes curing.

Instead of or in addition to the monomer having two or more ethylenically unsaturated groups, a monomer having a crosslinkable functional group may be used to introduce a crosslinkable functional group into the polymer so that the crosslinkable functional group is reacted to introduce a crosslinked structure into the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

The light-scattering layer preferably comprises an inorganic filler composed of oxide of at least one of metals such as titanium, zirconium, aluminum, indium, zinc, tin and antimony having an average particle diameter of 0.2 μm or less, preferably 0.1 μm or less, even more preferably 0.06 μm or less incorporated therein in addition to the aforementioned light-transmitting particulate material to enhance the refractive index thereof.

On the contrary, in order to increase the difference in refractive index from the light-transmitting particulate material, the light-scattering layer comprising a high refractive light-transmitting particulate material incorporated therein preferably comprises a silicon oxide incorporated therein for keeping the refractive index thereof low. The preferred particle diameter of the silicon oxide is the same as that of the aforementioned inorganic filler. These inorganic fillers normally have a higher specific gravity than organic materials and thus can enhance the density of the coating composition. Accordingly, these inorganic fillers have an effect of retarding the sedimentation of the light-transmitting particulate material.

These inorganic fillers are preferably subjected to silane coupling treatment or titanium coupling treatment on the surface thereof. A surface treatment having a functional group reactive with a binder seed on the surface of filler is preferably used.

The added amount of these inorganic fillers, if used, is preferably from 10 to 90%, more preferably from 20 to 80%, particularly from 30 to 75% based on the total mass of the hard coating layer.

The inorganic filler has a sufficiently smaller particle diameter than the wavelength of light and thus is not scattered. Thus, a dispersion of the filler in a binder polymer behaves as an optically uniform material.

The light-scattering layer may also comprise an organosilane compound incorporated therein. The amount of the organosilane compound to be incorporated in the layer is preferably from 0.001 to 50% by mass, more preferably from 0.01 to 20% by mass, even more preferably 0.05 to 10% by mass, particularly from 0.1 to 5% by mass based on the total solid content of the layer in which it is incorporated.

<Surface Active Agent for Light-Scattering Layer>

The coating composition for light-scattering layer of the invention may comprise either or both of a fluorine-based surface active agent and a silicone-based surface active agent incorporated therein to assure uniformity in surface conditions such as coating uniformity, drying uniformity and point defect. In particular, a fluorine-based surface active agent is preferably used in a smaller amount because it can exert an effect of eliminating defects in surface conditions such as coating unevenness, drying unevenness and point defect.

In this manner, the light-scattering layer-forming coating composition can be rendered adaptable to high speed coating while enhancing the uniformity in surface conditions so as to enhance the productivity.

Preferred examples of the fluorine-based polymer include fluoroaliphatic group-containing copolymers (hereinafter occasionally abbreviated as “fluorine-based polymer”). Useful examples of the fluorine-based polymer include acrylic resins and methacrylic resins containing repeating units corresponding to the following monomer (i) and repeating units corresponding to the following monomer (ii), and copolymers of these monomers with vinyl-based monomers copolymerizable therewith.
(i) Fluoroaliphatic Group-Containing Monomer Represented by the Following General Formula (a) 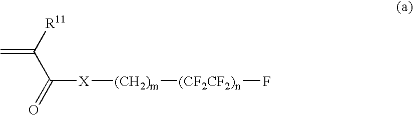
wherein R¹¹ represents a hydrogen atom or methyl group; X represents an oxygen atom, sulfur atom or —N(R¹²)—, preferably oxygen atom; m represents an integer of from not smaller than 1 to not greater than 6; n represents an integer of from 2 to 4; and R¹² represents a hydrogen atom or C₁-C₄ alkyl group such as methyl, ethyl, propyl and butyl, preferably hydrogen atom or methyl group.
(ii) Monomer Represented by the Following General Formula (b) Copolymerizable with the Monomer (i) 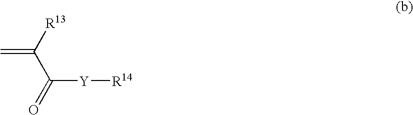
wherein R¹³ represents a hydrogen atom or methyl group; and Y represents an oxygen atom, sulfur atom or —N(R¹⁵)— in which R¹⁵ represents a hydrogen atom or a C₁-C₄ alkyl group such as methyl, ethyl, propyl and butyl, preferably hydrogen atom or methyl. Y is preferably an oxygen atom, —N(H)— or —N(CH₃)—.

R¹⁴ represents a C₄-C₂₀ straight-chain, branched or cyclic alkyl group which may have substituents. Examples of the substituents on the alkyl group represented by R¹⁴ include hydroxyl groups, alkylcarbonyl groups, arylcarbonyl groups, carboxyl groups, alkylether groups, arylether groups, halogen atoms such as fluorine atom, chlorine atom and bromine atom, nitro group, cyano group, and amino group. The invention is not limited to these substituents. As the C₄-C₂₀ straight-chain, branched or cyclic alkyl group there may be preferably used butyl, pentyl, hexyl, heptyl, octyl, nonyl, decyl, undecyl, dodecyl, tridecyl, tetradecyl, pentadecyl, octadecyl or eicosanyl group which may be straight-chain or branched, a monocyclic cycloalkyl or bicycloheptyl group such as cyclohexyl and cycloheptyl or polycyclic cycloalkyl group such as bicycloheptyl, bicyclodecyl, tricycloundecyl, tetracyclododecyl, adamanthyl, norbonyl and tetracyclodecyl.

The proportion of the fluoroaliphatic group-containing monomer represented by the general formula (b) in the amount of fluorine-based polymer to be used in the invention is 10 mol % or more, preferably from 15 to 70 mol %, more preferably from 20 to 60 mol %.

The mass-average molecular mass of the fluorine-based polymer to be used in the invention is preferably from 3,000 to 100,000, more preferably from 5,000 to 80,000.

The added amount of the fluorine-based polymer to be used in the invention is preferably from 0.001 to 5% by mass, more preferably from 0.005 to 3% by mass, even more preferably from 0.01 to 1% by mass based on the mass of the coating solution. When the added amount of the fluorine-based polymer falls below 0.001% by mass, the resulting effect is insufficient. On the contrary, when the added amount of the fluorine-based polymer exceeds 5% by mass, the resulting coating layer cannot be sufficiently dried and the properties of the coating layer (e.g., reflectance, scratch resistance) can be adversely affected.

Specific examples of the structure of fluorine-based polymer comprising a fluoroaliphatic group-containing monomer represented by the general formula (a) will be given below, but the invention is not limited thereto. The figure in the following general formulae indicates the molar fraction of the various monomer components. Mw indicates the mass-average molecular mass.

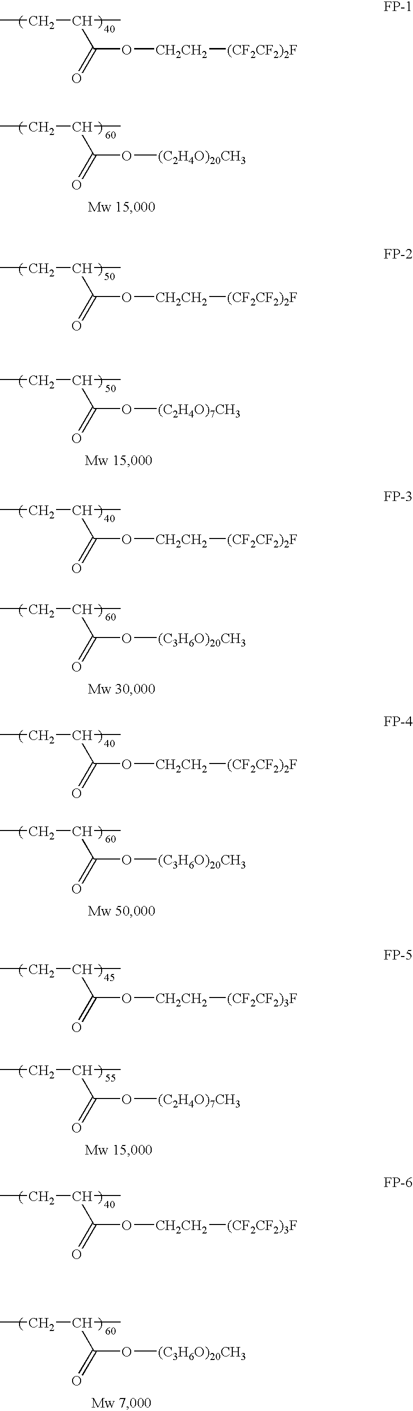

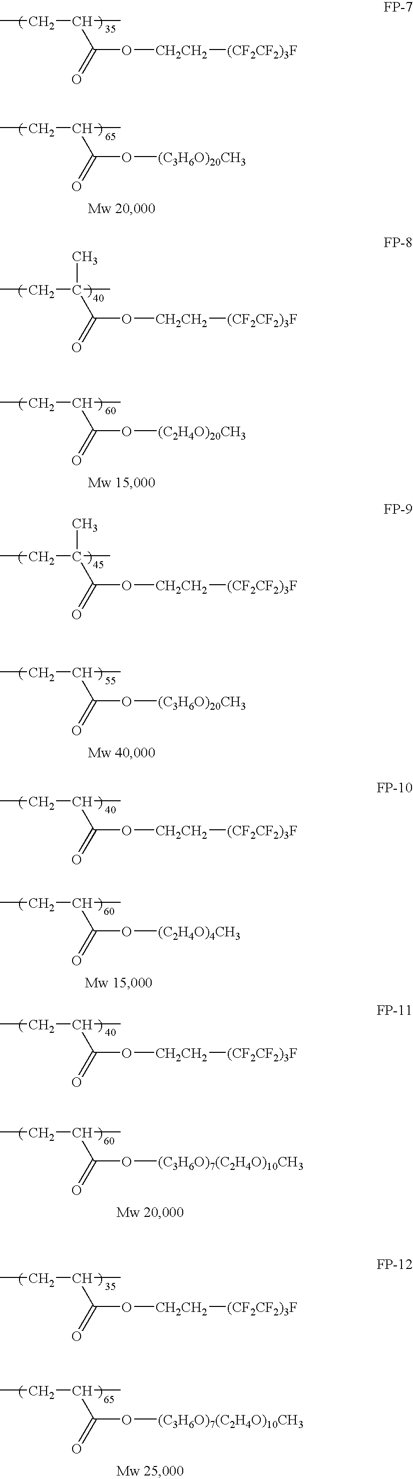

However, the use of the aforementioned fluorine-based polymer causes fluorine atom-containing functional groups to be segregated on the surface of the light-scattering layer. Thus, the surface energy of the light-scattering layer is reduced, raising a problem that when a low refractive layer is overcoated on the light-scattering layer, the resulting anti-reflection properties can be deteriorated. This is presumably because the light-scattering layer having a reduced surface energy exhibits a deteriorated wettability by the curable composition forming the low refractive layer, causing the increase of the amount of visually undetectable fine unevenness formed on the low refractive layer. It was found that this problem can be effectively solved by properly adjusting the structure and added amount of the fluorine-based polymer such that the surface energy of the light-scattering layer is controlled preferably to a range of from 20 mN·m⁻¹ to 50 mN·m⁻¹, more preferably from 30 mN·m⁻¹ to 40 mN·m⁻¹. In order to realize the above defined surface energy, the ratio F/C of peak derived from fluorine atom to peak derived from carbon atom as measured by X-ray photoelectron spectrometry needs to be from 0.1 to 1.5.

Further, in order to form the overlying layer, a fluorine-based polymer that can be extracted with the solvent constituting the overlying layer may be used. In this arrangement, the maldistribution of the overlying layer over the surface of the underlying layer (=interface) can be prevented to keep the overlying layer and the underlying layer adhesive to each other. Thus, even when spreading is effected at a high speed, an anti-reflection film having surface conditions kept uniform over the entire surface thereof and a high scratch resistance can be provided. The use of such a fluorine-based polymer also makes to prevent the reduction of surface free energy. Thus, the surface energy of the light-scattering layer before the spreading of the low refractive layer coating composition can be controlled to the above defined range, making it possible to accomplish the aim of the invention. Examples of the fluorine-based polymer include acrylic resins and methacrylic resins containing repeating units corresponding to a fluoroaliphatic group-containing monomer represented by the following monomer (c), and copolymers of these monomers with vinyl-based monomers copolymerizable therewith.
(iii) Fluoroaliphatic Group-Containing Monomer Represented by the Following General Formula (c) 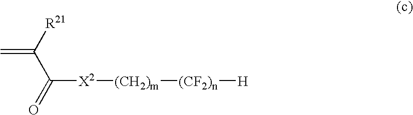
wherein R²¹ represents a hydrogen atom, halogen atom or methyl group, preferably hydrogen atom or methyl group; X² represents an oxygen atom, sulfur atom or —N(R²²)— (in which R²² represents a hydrogen atom or C₁-C₈ alkyl group which may have substituents, preferably hydrogen atom or C₁-C₄ alkyl group, more preferably hydrogen atom or methyl group), preferably oxygen atom or —N(R²²)—, more preferably oxygen atom; m represents an integer of from 1 to 6, preferably from 1 to 3, more preferably 1; and n represents an integer of from 1 to 18, preferably from 4 to 12, more preferably from 6 to 8. X² is preferably an oxygen atom.

The fluorine-based polymer may comprise as constituents two or more polymerizing units derived from fluoroaliphatic group-containing monomers represented by the following general formula (c).
(iv) Monomer Represented by the Following General Formula (d) Copolymerizable with the Monomer (iii) 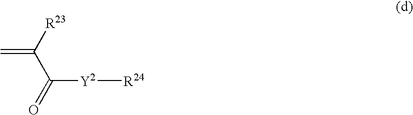
wherein R²³ represents a hydrogen atom, halogen atom or methyl group, preferably hydrogen atom or methyl group; Y² represents an oxygen atom, sulfur atom or —N(R²)—, preferably oxygen atom or —N(R²⁵)—, more preferably oxygen atom; and R²⁵ represents a hydrogen atom or C₁-C₈ alkyl group, preferably hydrogen atom or C₁-C₄ alkyl group, more preferably hydrogen atom or methyl group.

R²⁴ represents a C₁-C₂₀ straight-chain, branched or cyclic alkyl group which may have substituents, an alkyl group containing a poly(alkyleneoxy) group or an aromatic group which may have substituents (e.g., phenyl, naphthyl), preferably C₁-C₁₂ straight-chain, branched or cyclic alkyl group, more preferably an aromatic group having from 6 to 18 carbon atoms in total, even more preferably C₁-C₈ straight-chain, branched or cyclic alkyl group.

Specific examples of the structure of fluorine-based polymer comprising a fluoroaliphatic group-containing monomer represented by the general formula (c) will be given below, but the invention is not limited thereto. The figure in the following general formulae indicates the molar fraction of the various monomer components. Mw indicates the mass-average molecular mass.

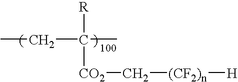

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

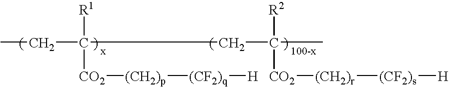

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

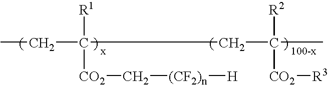

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 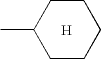 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 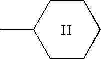 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

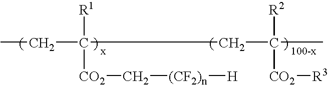

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)HD 13—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉-CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

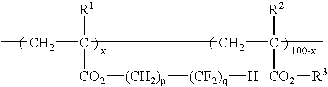

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₉—CH₃ | 16000 |
| 194 | | | | | | | |
| FP- | 90 | CH₃ | 2 | 4 | F | C₆H₁₃(n) | 24000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇—H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | CH₂CH(C₂H₅)C₄H₉(n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉₍ₙ₎ | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉₍ₙ₎ | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | CH₂CH(C₂H₅)C₄H₉(n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

By preventing the drop of the surface energy at the time when the light-scattering layer is coated with a low refractive layer, the deterioration of the anti-reflection properties can be prevented. The aim of the invention can be accomplished also by controlling the surface energy of the light-scattering layer before the spreading of low refractive layer coating solution within the above defined range. In some detail, during the spreading of the light-scattering layer coating solution, a fluorine-based polymer may be used to reduce the surface tension of the coating solution and hence raise the uniformity in surface conditions, making it possible to maintain a high productivity by high speed coating. The light-scattering layer thus formed may be then subjected to surface treatment such as corona treatment, UV treatment, heat treatment, saponification and solvent treatment, particularly preferably corona treatment, to prevent the drop of surface free energy.

The inventors also confirmed that the distribution of intensity of scattered light rays measured by goniophotometer is related to the effect of enhancing viewing angle. In other words, as the light rays emitted by the back light are diffused more by a light-diffusing film disposed on the viewing side polarizing plate, the viewing angle properties are better. However, when the light rays emitted by the back light are diffused too much, there occurs much back scattering that causes the reduction of front brightness or the deterioration of image sharpness. Accordingly, it is necessary that the distribution of intensity of scattered light be controlled within a predetermined range. As a result of extensive studies, it was found that in order to attain desired viewing properties, the intensity of scattered light at an angle of 30°, particularly related to the effect of enhancing viewing angle, with respect to the intensity of light at an emission angle of 0° in scattered light profile is preferably from 0.01% to 0.2%, more preferably from 0.02% to 0.15%.

For the determination of scattered light profile, the light-scattering film thus prepared may be measured using a GP-5 goniophotometer (produced by MURAKAMI COLOR RESEARCH LABORATORY).

Further, the coating composition for forming the light-scattering layer of the invention may comprise a thixotropic agent incorporated therein. Examples of the thixotropic agent employable herein include silica and mica having a particle size of 0.1 μm or less. In general, the content of these additives is preferably from about 1 to 10 parts by mass based on 100 parts by mass of ultraviolet-curing resin.

The aforementioned low refractive layer will be further described hereinafter.

<Low Refractive Layer>

The refractive index of the low refractive layer in the anti-reflection film of the invention is preferably from 1.30 to 1.55, more preferably from 1.35 to 1.45.

When the refractive index of the low refractive layer falls below 1.30, the resulting low refractive layer exhibits enhanced anti-reflection properties but deteriorated film mechanical strength. When the refractive index of the low refractive layer exceeds 1.55, the resulting low refractive layer exhibits remarkably deteriorated anti-reflection properties.

The low refractive layer preferably satisfies the following numerical relationship (I) from the standpoint of reduction of reflectance.
(m/4)×0.7<n1×d1<(m/4)×1.3 (I)
wherein m represents a positive odd number; n1 represents the refractive index of the low refractive layer; and d1 represents the thickness (nm) of the low refractive layer. λ indicates wavelength falling within a range of from 500 to 550 nm.

The satisfaction of the aforementioned numerical relationship (I) means that there is m (positive odd number, normally 1) satisfying the numerical relationship (I) in the above defined range of wavelength.

The material constituting the low refractive layer will be further described hereinafter.

The low refractive layer is a cured layer formed by spreading a curable composition mainly composed of a fluorine-containing polymer, and then drying and curing the coating layer.

<Fluorine-Containing Polymer for Low Refractive Layer>

The aforementioned fluorine-containing polymer is preferably one which exhibits a dynamic friction coefficient of from 0.03 to 0.20, a contact angle of from 90° to 120° with respect to water and a pure water slipping angle of 70° or less when cured to form a cured layer and undergoes crosslinking when heated or irradiated with ionizing radiation from the standpoint of enhancement of productivity in a process involving spreading and curing over the web which is being conveyed from roll.

In the case where the anti-reflection film of the invention is mounted on an image display device, the lower the peeling force of the low refractive layer off a commercially available adhesive tape is, the more can be easily peeled a seal or adhesive memo pad off the low refractive layer. Thus, the peeling force of the low refractive layer with respect to these materials is preferably 500 gf or less, more preferably 300 gf or less, most preferably 100 gf or less. The higher the surface hardness of the low refractive layer as measured by a microhardness tester is, the more difficulty can be scratched the low refractive layer. Thus, the surface hardness of the low refractive layer is preferably 0.3 GPa or more, more preferably 0.5 GPa or more.

The fluorine-containing polymer to be used in the low refractive layer is one containing fluorine atoms in an amount of from 35 to 80% by mass and a crosslinkable or polymerizable functional group. Examples of the fluorine-containing polymer employable herein include hydrolyzates and dehydration condensates of perfluoroalkyl group-containing silane compounds [e.g., (heptadecafluoro-1,1,2,2-tetrahydrodecyl)triethoxysilane], and fluorine-containing copolymers comprising a fluorine-containing monomer unit and a crosslinking reactive unit as constituent units. The aforementioned fluorine-containing copolymer, if used, preferably comprises a main chain composed of only carbon atoms. In other words, the main chain skeleton of the fluorine-containing copolymer is preferably free of oxygen atoms, nitrogen atoms, etc.

Specific examples of the aforementioned fluorine-containing monomer unit include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.)), and fully or partly-fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the aforementioned crosslinking reactive unit include constituent units obtained by the polymerization of monomers previously having a self-crosslinkable functional group in molecule such as glycidyl (meth)acrylate and glycidyl vinyl ether, constituent units obtained by the polymerization of monomers having carboxyl group, hydroxyl group, amino group, sulfo group, etc. (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid), and constituent units obtained by introducing a crosslinkable functional group such as (meth)acryloyl group into these constituent units by a polymer reaction (e.g., method involving the reaction of hydroxyl group with acrylic acid chloride).

Besides the aforementioned fluorine-containing monomer units and crosslinking reactive units, fluorine-free monomers may be properly copolymerized to introduce other polymerizing units from the standpoint of solubility in solvent, transparency of film, etc. The monomers to be used in combination with the aforementioned constituent units are not specifically limited. Examples of these monomers include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (methyl methacrylate, ethyl methacrylate, butyl methacrylate, ethylene glycol dimethacrylate), styrene derivatives (e.g., styrene, divinyl benzene, vinyl toluene, α-methylstyrene), vinyl ethers (e.g., methyl vinyl ether, ethyl vinyl ether, cyclohexyl vinyl ether), vinyl esters (e.g., vinyl acetate, vinyl priopionate, vinyl cinnamate), acrylamides (e.g., N-tert butylacrylamide, N-cyclohexyl acrylamide), methacrylamides, and acrylonitrile derivatives.

The aforementioned fluorine-containing polymers may be used properly in combination with a curing agent as disclosed in JP-A-10-25388 and JP-A-10-147739.

The fluorine-containing polymer which is particularly preferred in the invention is a random copolymer of perfluoroolefin with vinyl ether or vinyl ester. It is particularly preferred that the fluorine-containing polymer have a group which can undergo crosslinking reaction by itself (e.g., radical-reactive group such as (meth)acryloyl group, ring-opening polymerizable group such as epoxy group and oxetanyl group).

These crosslinkable functional group-containing polymerizing units preferably account for from 5 to 70 mol %, particularly from 30 to 60 mol % of the total polymerizing units of the polymer.

Preferred embodiments of the fluorine-containing polymer for low refractive layer to be used in the invention include a copolymer represented by the following general formula (1):

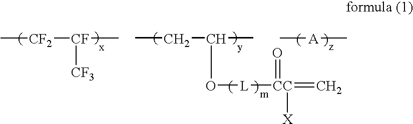

In the general formula (1), L represents a C₁-C₁₀ connecting group, preferably a C₁-C₆ connecting group, particularly C₂-C₄ connecting group. The connecting group may be straight-chain or may have a branched or cyclic structure. The connecting group may have hetero atoms selected from the group consisting of oxygen, nitrogen and sulfur.

Preferred examples of L include *—(CH₂)₂—O—**, *—(CH₂)₂—NH—**, *—(CH₂)₄—O—**, *(CH₂)₆—O—**, *—(CH₂)₂—O— (CH₂)₂—O—**, *—CONH—(CH₂)₃—O—**, *—CH₂CH(OH)CH₂—O—**, and *—CH₂CH₂OCONH(CH₂)₃—O—** (in which * indicates the connecting site on the polymer main chain side and ** indicates the connecting site on the (meth)acryloyl group site). The suffix m represents 0 or 1.

In the general formula (1), X represents a hydrogen atom or methyl group, preferably hydrogen atom from the standpoint of curing reactivity.

In the general formula (1), the group A represents a repeating unit derived from arbitrary vinyl monomer. The repeating unit is not specifically limited so far as it is a constituent of a monomer copolymerizable with hexafluoropropylene. The repeating unit may be properly selected from the standpoint of adhesion to substrate, Tg of polymer (contributing to film hardness), solubility in solvent, transparency, slipperiness, dustproofness, stainproofness, etc. The repeating unit may be composed of a single or a plurality of vinyl monomers depending on the purpose.

Preferred examples of the aforementioned vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl methacrylate, allyl (meth)acrylate and (meth)acryloyloxypropyl trimethoxysilane, styrene derivatives such as styrene and p-hydroxymethylstyrene, unsaturated carboxylic acids such as crotonic acid, maleic acid and itaconic acid, and derivatives thereof. More desirable among these vinyl monomers are vinyl ether derivatives and vinyl ester derivatives. Particularly preferred among these vinyl monomers are vinyl ether derivatives.

The suffixes x, y and z each represents the molar percentage of the respective constituent component and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10, with the proviso that the sum of x, y and z is 100.

A particularly preferred embodiment of the copolymer to be used in the invention is one represented by the general formula (2).

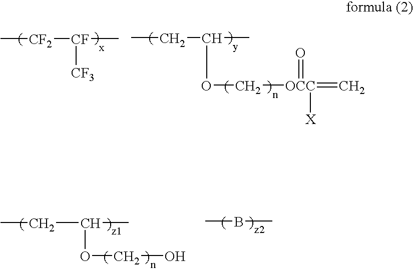

In the general formula (2), X and its preferred range are as defined in the general formula (1).

The suffix n represents an integer of from not smaller than 2 to not greater than 10, preferably from not smaller than 2 to not greater than 6, particularly from not smaller than 2 to not greater than 4.

The group B represents a repeating unit derived from arbitrary vinyl monomer. The repeating unit may be composed of a single composition or a plurality of compositions. Examples of the repeating unit include those listed above with reference to the group A in the general formula (1).

The suffixes x, y, z1 and z2 each represents the molar percentage of the respective repeating unit. The suffixes x and y preferably satisfy the relationship 30≦x≦60 and 5≦y≦70, more preferably 35≦x≦55 and 30≦y≦60, particularly 40≦x≦55 and 40≦y≦55. The suffixes z1 and z2 preferably satisfy the relationship 0≦z1≦65 and 0≦z2≦65, preferably 0≦z1≦30 and 0≦z2≦10, particularly 0≦z1≦10 and 0≦z2≦5. However, the sum of x, y, z1 and z2 is 100.

The copolymer represented by the general formula (1) or (2) can be synthesized by introducing a (meth) acryloyl group into a copolymer comprising a hexafluoropropylene component and a hydroxyalkylvinyl ether component by any of the aforementioned methods. Preferred examples of the reprecipitating solvent to be used in this synthesis method include isopropanol, hexane, and methanol.

Specific examples of the copolymer represented by the general formula (1) or (2) include those disclosed in paragraphs [0035] to [0047] in JP-A-2004-45462. These copolymers can be synthesized by the methods disclosed in the above cited patent.

The aforementioned curable composition preferably comprises (A) the aforementioned fluorine-containing polymer, (B) an inorganic particulate material and (C) an organosilane compound described later.

<Inorganic Particulate Material for Low Refractive Layer>

The spread of the inorganic particulate material is preferably from 1 mg/m² to 100 mg/m², more preferably from 5 mg/m² to 80 mg/m², even more preferably from 10 mg/m² to 60 mg/m². When the spread of the inorganic particulate material is too low, the effect of improving scratch resistance is eliminated. On the other hand, when the spread of the inorganic particulate material is too high, fine roughness can be formed on the surface of the low refractive layer, causing the deterioration of the external appearance such as black tone and density and integrated reflectance. Thus, the spread of the inorganic particulate material preferably falls within the above defined range.

The inorganic particulate material preferably has a low refractive index because it is incorporated in the low refractive layer. Examples of the inorganic particulate material include particulate magnesium fluoride and silica. Particulate silica is particularly preferred from the standpoint of refractive index, dispersion stability and cost.

The average particle diameter of the inorganic particulate material is preferably from not smaller than 30% to not greater than 100%, more preferably from not smaller than 35% to not greater than 80%, even more preferably from 40% to not greater than 60% of the thickness of the low refractive layer. In some detail, when the thickness of the low refractive layer is 100 nm, the particle diameter of the particulate silica is preferably from not smaller than 30 nm to not greater than 100 nm, more preferably from not smaller than 35 nm to not greater than 80 nm, even more preferably from not smaller than 40 nm to not greater than 60 nm.

When the particle diameter of the inorganic particulate material is too low, the effect of improving scratch resistance is eliminated. On the other hand, when the particle diameter of the inorganic particulate material is too high, fine roughness can be formed on the surface of the low refractive layer, causing the deterioration of the external appearance such as black tone and density and integrated reflectance. Thus, the particle diameter of the inorganic particulate material preferably falls within the above defined range. The inorganic particulate material may be crystalline or amorphous. The inorganic particulate material may be monodisperse or may be composed of agglomerated particles so far as they have a predetermined particle diameter. The shape of the inorganic particulate material is most preferably sphere but may be amorphous.

For the measurement of the average particle diameter of the particulate inorganic material, a coulter counter may be used.

In order to reduce the refractive index of the low refractive layer, a hollow particulate silica (hereinafter occasionally referred to as “hollow particulate material”) is preferably used. The refractive index of the hollow particulate material is preferably from 1.17 to 1.40, more preferably from 1.17 to 1.35, even more preferably from 1.17 to 1.30. The refractive index used herein means the refractive index of the entire particulate material rather than the refractive index of only the inorganic material of the shell of the hollow inorganic particulate material. Supposing that the radius of the bore of the particle is a and the radius of the shell of the particle is b, the percent void x is represented by the following numerical formula (II):
x=(4πa³/3)/(4πb³/3)×100 (%) (II)

The percent void x of the hollow inorganic particulate material is preferably from 10% to 60%, more preferably from 20% to 60%, most preferably from 30% to 60%.

As the refractive index of the hollow inorganic particulate material decreases from the above defined range and the percentage void of the hollow inorganic particulate silica rises from the above defined range, the thickness of the shell decreases, reducing the strength of the particulate material. Therefore, a particulate material having a refractive index as low as less than 1.17 is impossible from the standpoint of scratch resistance.

For the measurement of the refractive index of these hollow inorganic particulate materials, an Abbe refractometer (produced by ATAGO CO., LTD.) was used.

Further, the low refractive layer may comprise at least one of particulate silica materials having an average particle diameter of less than 25% of the thickness of the low refractive layer (hereinafter referred to as “small particle size inorganic particulate material”) incorporated therein in combination with the aforementioned particulate silica (hereinafter referred to as “large particle size inorganic particulate material”).

The small particle size inorganic particulate material can be present in the gap between the large size inorganic particles and thus can act as a retainer for large particle diameter inorganic particulate material. In the case where the thickness of the low refractive layer is 100 nm, the average particle diameter of the small particle diameter inorganic particulate material is preferably from not smaller than 1 nm to not greater than 20 nm, more preferably from not smaller than 5 nm to not greater than 15 nm, particularly from not smaller than 10 nm to not greater than 15 nm. The use of such an inorganic particulate material is advantageous in material cost and effect of retainer.

As mentioned above, as the inorganic particulate material, an inorganic particulate material having a hollow structure having an average particle diameter of from 30 to 100% of the thickness of the low refractive layer and a refractive index of from 1.17 to 1.40 is particularly preferred.

The inorganic particulate material may be subjected to physical surface treatment such as plasma discharge and corona discharge or chemical surface treatment with a surface active agent, coupling agent or the like to enhance the stability of dispersion in the dispersion or coating solution or the affinity for or the bonding properties with the binder component. As the coupling agent there is preferably used an alkoxy metal compound (e.g., titanium coupling agent, silane coupling agent). Particularly effective among these surface treatments is silane coupling treatment.

The aforementioned coupling agent is used as a surface treatment for the inorganic particulate material in the low refractive layer to effect surface treatment before the preparation of the layer coating solution. The coupling agent is preferably incorporated as additive in the low refractive layer during the preparation of the layer coating solution.

It is preferred that the inorganic particulate material be previously dispersed in the medium to reduce the burden of surface treatment.

The organosilane compound (C) will be further described hereinafter.

<Organosilane Compound for Low Refractive Layer>

The aforementioned curable composition preferably comprises a hydrolyzate and/or partial condensate of organosilane compound, etc. (hereinafter, the resulting reaction solution will be referred to also as “sol component”) incorporated therein from the standpoint of scratch resistance, particularly in combination with anti-reflection properties.

The aforementioned curable composition comprising such a sol component is spread, dried, and then condensed at the heating step to form a cured material which acts as a binder for the low refractive layer. In the invention, since the coating composition comprises the aforementioned fluorine-containing polymer, the cured material is irradiated with active light rays to form a binder having a three-dimensional structure.

The aforementioned organosilane compound is preferably one represented by the following general formula [A].
(R¹⁰)ₘSi(X)₄₋ₘ [A]

In the general formula [A], R¹⁰ represents a substituted or unsubstituted alkyl or aryl group. Examples of the alkyl group include methyl, ethyl, propyl, isopropyl, hexyl, decyl, and hexadecyl. The alkyl group preferably has from 1 to 30, more preferably from 1 to 16, particularly from 1 to 6 carbon atoms. Examples of the aryl group include phenyl, and naphthyl. Preferred among these aryl groups is phenyl.

X represents a hydroxyl group or hydrolyzable group. Examples of these groups include alkoxy groups (preferably alkoxy groups having from 1 to 5 carbon atoms such as methoxy and ethoxy), halogen atoms (e.g., Cl, Br, I), and groups represented by R²COO (in which R² is preferably a hydrogen atom or C₁-C₅ alkyl group such as CH₃COO and C₂H₅COO). Preferred among these groups are alkoxy groups. Particularly preferred among these alkoxy groups are methoxy and ethoxy.

The suffix m represents an integer of from 1 to 3, preferably 1 or 2, particularly 1.

The plurality of R¹⁰'s or X's, if any, may be the same or different.

The substituents on R¹⁰ are not specifically limited but may be halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkenyl groups (e.g., vinyl, 1-propenyl), acyloxy groups (e.g., acetoxy, acryloyloxy, methacryloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (acetylamino, benzoylamino, acrylamino, methacryl amino). These substituents may be further substituted.

At least one of the plurality of R¹⁰'s, if any, is preferably a substituted or unsubstituted alkyl or aryl group.

Preferred among the organosilane compounds represented by the general formula [A] is an organosilane compound having a vinyl-polymerizable substituent represented by the following general formula [B]:

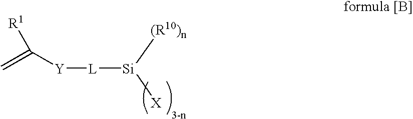

In the general formula [B], R¹ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

Y represents a single bond, *—COO—**, *—CONH—** or *—O—**, preferably single bond, *—COO—** or *—CONH—**, more preferably single bond or *—COO—**, particularly * COO—**. The symbol * indicates the position at which the group is connected to ═C(R¹)—. The symbol ** indicates the position at which the group is connected to L.

L represents a divalent connecting chain. Specific examples of the divalent connecting chain include substituted or unsubstituted alkylene or arylene group, substituted or unsubstituted alkylene group having a connecting group (e.g., ether, ester, amide) therein, and substituted or unsubstituted arylene group having a connecting group therein. Preferred among these divalent connecting chains are substituted or unsubstituted alkylene or arylene group, and substituted or unsubstituted alkylene group having a connecting group therein. More desirable among these divalent connecting chains are unsubstituted alkylene group, unsubstituted arylene group, and substituted or unsubstituted alkylene group having a connecting group therein. Particularly preferred among these divalent connecting chains are unsubstituted alkylene group, and substituted or unsubstituted alkylene group having a connecting group therein. Examples of the substituents on these groups include halogen atoms, hydroxyl groups, mercapto groups, carboxyl groups, epoxy groups, alkyl groups, and aryl groups. These substituents may be further substituted.

The suffix n represents 0 or 1. The plurality of X's, if any, may be the same or different. The suffix n is preferably 0.

R¹⁰ is as defined in the general formula [A]. R¹⁰ is preferably a substituted or unsubstituted alkyl or aryl group, more preferably unsubstituted alkyl or aryl group.

X is as defined in the general formula [A]. X is preferably a halogen atom, hydroxyl group or unsubstituted alkoxy group, more preferably chlorine, hydroxyl group or unsubstituted C₁-C₆ alkoxy group, even more preferably hydroxyl group or C₁-C₃ alkoxy group, particularly methoxy group.

Two or more of the compounds of the general formulae [A] and [B] may be used in combination. Specific examples of the compounds represented by the general formulae [A] and [B] will be given below, but the invention is not limited thereto.

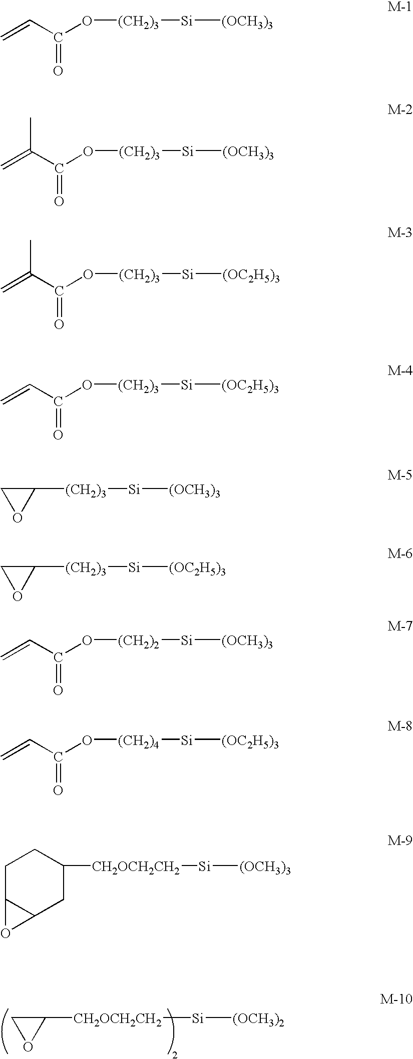

Particularly preferred among these compounds are (M-1), (M-2) and (M-5).

The hydrolyzate and/or partial condensate of organosilane compound are normally produced by treating the aforementioned organosilane compound in the presence of a catalyst. Examples of the catalyst employable herein include inorganic acids such as hydrochloric acid, sulfuric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. In the invention, metal chelate compounds and inorganic and organic acid catalysts are preferably used. Preferred among these inorganic acids are hydrochloric acid and sulfuric acid. Preferred among these inorganic acids are those having an acid dissociation constant {pKa value (25° C.)} of 4.5 or less in water. More desirable among these acids are hydrochloric acid, sulfuric acid and organic acid having an acid dissociation constant of 3.0 or less in water. Particularly preferred among these acids are hydrochloric acid, sulfuric acid and organic acid having an acid dissociation constant of 2.5 or less in water. Even more desirable among these acids are those having an acid dissociation constant of 2.5 or less in water. In some detail, methanesulfonic acid, oxalic acid, phthalic acid and malonic acid are more desirable, particularly oxalic acid.

As the metal chelate compound there may be used one having an alcohol represented by the general formula R³OH (in which R³ represents a C₁-C₁₀ alkyl group) and a compound represented by the general formula R⁴COCH₂COR⁵ (in which R⁴ represents a C₁-C₁₀ alkyl group and R⁵ represents a C₁-C₁₀ alkyl group or C₁-C₁₀ alkoxy group) as a ligand and a metal selected from the group consisting of zirconium, titanium and aluminum as a central metal without any limitation. Two or more metal chelate compounds may be used in combination if they fall within this category. The metal chelate compound to be used in the invention is preferably selected from the group consisting of compounds represented by the following general formulae:
Zr(OR³)ₚ₁(R⁴COCHCOR⁵)ₚ₂;
Ti(OR³)_{q1}(R⁴COCHCOR⁵)_{q2}; and
Al(OR³)ᵣ₁(R⁴COCHCOR⁵)ᵣ₂
The metal chelate compound of the invention acts to accelerate the condensation reaction of hydrolyzate and/or partial condensate of the organosilane compound.

R³ and R⁴ in the metal chelate compound may be the same or different and each represent a C₁-C₁₀ alkyl group such as ethyl, n-propyl, i-propyl, n-butyl, sec-butyl, t-butyl and n-pentyl or phenyl. R⁵ represents the same C₁-C₁₀ alkyl group as defined above or C₁-C₁₀ alkoxy group such as methoxy, ethoxy, n-propoxy, i-propoxy, n-butoxy, sec-butoxy and t-butoxy. The suffixes p1, p2, q1, q2, r1 and r2 in these general formulae each represent an integer determined to satisfy the numerical formulae: P1+p2=4, q1+q2=4 and r1+r2=3.

Specific examples of these metal chelate compounds include zirconium chelate compounds such as tri-n-butoxy ethyl acetoacetate zirconium, di-n-butoxybis(ethyl acetoacetate)zirconium, n-butoxytris(ethylaceto acetate)zirconium, tetrakis(n-propylacetoacetate) zirconium, tetrakis(acetylacetoacetate)zirconium and tetrakis(ethylacetoacetate)zirconium, titanium compounds such as diisopropoxy bis(ethylacetoacetate) titanium, diisopropoxy bis(acetylacetate)titanium and diisopropoxy bis(acetylacetone)titanium, and aluminum chelate compounds such as diisopropoxyethyl acetoacetate aluminum, diisopropoxyacetylacetonate aluminum, isopropoxy bis(ethylacetoacetate)aluminum, isoproposy bis(acetylacetonate)aluminum, tris(ethyl acetoacetate)aluminum, tris(acetylacetonate)aluminum and monoacetyl acetonate bis(ethylacetoacetate) aluminum.

Preferred among these metal chelate compounds are tri-n-butoxyethyl acetoacetate zirconium, diisopropoxy bis(acetylacetonate)titanium, diisopropoxy ethyl acetoacetate aluminum and tris(ethylacetoacetate) aluminum. These metal chelate compounds may be used singly or in combination of two or more thereof. Alternatively, these metal chelate compounds may be used in the form of partial hydrolyzate.

In the invention, the aforementioned curable composition preferably comprises a diketone compound and/or a β-ketoester compound incorporated therein. This will be further described hereinafter.

In the invention, β-diketone and/or β-ketoester compounds represented by the general formula R⁴COCH₂COR⁵ are used. These compounds each act as a stability improver for the composition to be used in the invention. R⁴ represents a C₁-C₁₀ alkyl group and R⁵ represents a C₁-C₁₀ alkyl or alkoxy group. In other words, it is thought that the coordination of these compounds to the metal atoms in the aforementioned metal chelate compound (zirconium, titanium and/or aluminum compounds) makes it possible to prevent these metal chelate compounds from accelerating the condensation reaction of the hydrolyzate and/or partial condensate of organosilane compound and hence enhance the storage stability of the resulting composition. R⁴ and R⁵ constituting the β-diketone compound and/or β-ketoester compound are as defined in the aforementioned metal chelate compound.

Specific examples of the β-diketone compound and/or β-ketoester compound include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these compounds are ethyl acetoacetate and acetyl acetone. Particularly preferred among these compounds is acetyl acetone. These β-diketone compounds and/or β-ketoester compounds may be used singly or in combination of two or more thereof. In the invention, the β-diketone compound and/or β-ketoester compound are preferably used in an amount of 2 mols or more, more preferably from 3 to 20 mols per mol of metal chelate compound. When the amount of the β-diketone compound and/or β-ketoester compound falls below 2 mols, the resulting composition can exhibit a deteriorated storage stability to disadvantage.

The content of the aforementioned organosilane compound in the low refractive layer is preferably from 0.1 to 50% by mass, more preferably from 0.5 to 20% by mass, most preferably from 1 to 10% by mass based on the total solid content of the low refractive layer.

The aforementioned organosilane compound may be directly incorporated in the curable composition (coating solution for light-scattering layer and low refractive layer). However, a reaction solution (sol) obtained by treating the aforementioned organosilane compound in the presence of a catalyst so that a hydrolyzate and/or partial condensate of the aforementioned organosilane compound is prepared is preferably used to prepare the aforementioned curable composition. In a preferred embodiment of the invention, a composition comprising a hydrolyzate and/or partial condensate of the aforementioned organosilane compound is firstly prepared. To the composition is then added a β-diketone compound and/or a β-ketoester compound. The solution is then incorporated in the coating solution of at least one of light-scattering layer and low refractive layer. The coating solution is then spread.

The content of the sol component of organosilane compound in the low refractive layer is preferably from 5 to 100% by mass, more preferably from 5 to 40% by mass, even more preferably from 8 to 35% by mass, particularly from 10 to 30% by mass based on the mass of the fluorine-containing polymer. When the content of the sol component is too low, the effect of the invention can be difficulty exerted. On the contrary, when the content of the sol component is too high, the resulting low refractive layer exhibits a raised refractive index and deteriorated film shape and surface conditions to disadvantage.

The aforementioned curable composition may comprise an inorganic filler other than the aforementioned inorganic particulate material incorporated therein in an amount such that the desired effect of the invention cannot be impaired. The inorganic filler will be further described later.

(Sol-Gel Material)

As the materials constituting the low refractive layer there may be also used various sol-gel materials. As these sol-gel materials there may be used metal alcoholates (alcoholate of silane, titanium, aluminum, zirconium, etc.), organoalkoxy metal compounds and hydrolyzates thereof. Particularly preferred among these sol-gel materials are alkoxysilane, organoalkoxysilane and hydrolyzates thereof. Examples of these sol-gel materials include tetraalkoxysilanes (e.g., tetramethoxysilane, tetraethoxysilane), alkyltrialkoxysilanes (methyl trimethoxysilane, ethyl trimethoxysilane), aryl trialkoxysilanes (e.g., phenyl trimethoxysilane), dialkyl dialkoxysilanes, and diaryl dialkoxysilanes. Other examples of these sol-gel materials employable herein include organoalkoxysilanes having various functional groups (e.g., vinyl trialkoxysilane, methyl vinyl dialkoxysilane, γ-glycidyloxy propyl trialkoxysilane, γ-glycidyloxy propyl methyl dialkoxysilane, β-(3,4-epoxydicyclohexyl)ethyl trialkoxysilane, γ-methacryloyloxypropyl trialkoxysilane, γ-aminopropyl trialkoxysilane, γ-mercaptopropyl trialkoxysilane, γ-chloropropyl trialkoxysilane), and perfluoroalkyl group-containing silane compounds (e.g., (heptadecafluoro-1,1,2,2-tetradecyl)triethoxysilane, 3,3,3-trifluoropropyl trimethoxysilane). In particular, the use of a fluorine-containing silane compound is advantageous in the reduction of refractive index of layer and the provision of water repellency and oil repellency.

[Other Materials to be Incorporated in Curable Composition for Low Refractive Layer]

The aforementioned curable composition is prepared by dissolving the aforementioned fluorine-containing polymer (A), inorganic particulate material (B) and organosilane compound (C) and optionally various additives, a radical polymerization initiator and a cationic polymerization initiator in a proper solvent. The concentration of solid content is properly predetermined depending on the purpose but is normally from about 0.01 to 60% by mass, preferably from about 0.5 to 50% by mass, particularly from about 1 to 20% by mass.

From the standpoint of interfacial adhesion to the underlying layer with which the low refractive layer comes in direct contact, the curable composition may comprise a curing agent such as polyfunctional (meth)acrylate, polyfunctional epoxy compound, polyisocyanate compound, aminoplast, polybasic acid and anhydride thereof incorporated therein in a small amount. The amount of the curing agent, if used, is preferably 30% by mass or less, 20% by mass or less, 10% by mass or less based on the total solid content of the low refractive layer.

For the purpose of providing properties such as stainproofness, water resistance, chemical resistance and slipperiness, a known silicone-based or fluorine-based stainproofing agent, a lubricant or the like may be properly added. These additives, if any, are preferably added in an amount of from 0.01 to 20% by mass, more preferably from 0.05 to 10% by mass, particularly from 0.1 to 5% by mass based on the solid content of the low refractive layer.

Preferred examples of the silicone-based compound include those containing a plurality of dimethyl silyloxy units as repeating units and having substituents at the end of chain and/or in side chains thereof. The compound chain containing dimethyl silyloxy as repeating unit may contain structural units other than dimethyl silyloxy. The substituents may be the same or different. It is preferred that there be a plurality of substituents. Preferred examples of the substituents include groups containing acryloyl group, methacryloyl group, aryl group, cinnamoyl group, epoxy group, oxetanyl group, hydroxyl group, fluoroalkyl group, polyoxyalkylene group, carboxyl group, amino group, etc. The molecular mass of the silicone-based compound is not specifically limited but is preferably 100,000 or less, particularly 50,000 or less, most preferably from 3,000 to 30,000. The content of silicon atoms in the silicone-based compound, too, is not specifically limited but is preferably 18.0% by mass or more, particularly from 25.0 to 37.8% by mass, most preferably from 30.0 to 37.0% by mass. Preferred examples of the silicone-based compound include X-22-174DX, X-22-2426, X-22-164B, X-22-164C, X-22-170DX, X-22-176D and X-22-1821 (produced by Shin-Etsu Chemical Co., Ltd.), FM-0725, FM-7725, FM-4421, FM-5521, FM-6621 and FM-1121 (produced by Chisso Corporation), and DMS-U22, RMS-033, RMS-083, UMS-182, DMS-H21, DMS-H31, HMS-301, FMS121, FMS123, FMS131, FMS141 and FMS221 (produced by Gelest, Inc.). However, the invention is not limited to these products.

As the fluorine-based compound there is preferably used a compound having a fluoroalkyl group. The fluoroalkyl group preferably has from 1 to 20 carbon atoms, more preferably from 1 to 10 carbon atoms, and may have a straight-chain structure [e.g., —CF₂CF₃, —CH₂(CF₂)₄H, —CH₂(CF₂)₈CF₃, —CH₂CH₂(CF₂)₄H], a branched structure [e.g., —CH(CF₃)₂, —CH₂CF(CF₃)₂, —CH(CH₃)CF₂CF₃, —CH(CH₃)(CF₂)₅CF₂H] or an alicyclic structure (preferably 5-membered or 6-membered ring such as perfluorocyclohexyl group, perfluorocyclopentyl group or alkyl group substituted thereby). The fluoroalkyl group may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of the fluoroalkyl groups may be incorporated in the same molecule.

The fluorine-based compound preferably further contain substituents contributing to the formation of bond to the low refractive layer or the compatibility with the low refractive layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group. The fluorine-based compound may be used in the form of polymer or oligomer with a fluorine-free compound. The fluorine-based compound may be used without any limitation on the molecular mass. The content of fluorine atoms in the fluorine-based compound is not specifically limited but is preferably 20% by mass or more, particularly from 30 to 70% by mass, most preferably from 40 to 70% by mass. Preferred examples of the fluorine-based compound include R-2020, M-2020, R3833 and M-3833 (produced by DAKIN INDUSTRIES, Ltd.), and Megafac F-171, Megafac F-172 and Megafac F-179A, Diffenser MCF-300 (produced by DAINIPPON INK AND CHEMICALS, INCORPORATED). However, the invention is not limited to these products.

For the purpose of providing properties such as dustproofing agent and antistatic properties, a dustproofing agent such as known cationic surface active agent and polyoxyalkylene-based compound, antistatic agent or the like may be properly added. Referring to these dustproofing agents and antistatic agents, the aforementioned silicone-based compound or fluorine-based compound may have its structural unit to act partly to perform such a performance. These additives, if any, are preferably added in an amount of from 0.01 to 20% by mass, more preferably from 0.05 to 10 by mass, particularly from 0.1 to 5% by mass based on the total solid content of the low refractive layer-forming composition. Preferred examples of these compounds include Megafac F-150 (produced by DAINIPPON INK AND CHEMICALS, INCORPORATED), and SH-3748 (produced by Toray Dow Corning Co., Ltd.). However, the invention is not limited to these products.

<Transparent Substrate>

As the transparent support for the light-scattering film or anti-reflection film of the invention there is preferably used a plastic film. Examples of the polymer constituting the plastic film include cellulose acylates {e.g., cellulose triacetate, cellulose diacetate, cellulose acetate propionate, cellulose acetate butyrate; Representative examples of these cellulose acylates include “TAC-TD80U” and “TD80UL”, produced by Fuji Photo Film Co., Ltd.}, polyamides, polycarbonates, polyesters (e.g., polyethylene terephthalate, polyethylene naphthalate), polystyrenes, polyolefins, norbornene-based resins {“Arton” (trade name), produced by JSR Co., Ltd.}, and amorphous polyolefins {“Zeonex” (trade name), produced by ZEON CORPORATION}. Preferred among these polymers are triacetyl cellulose, polyethylene terephthalate, and polyethylene naphthalate. Particularly preferred among these polymers is triacetyl cellulose.

A cellulose acylate film is composed of a single layer or a plurality of layers. The single-layer cellulose acylate film is formed by drum casting method disclosed in JP-A-7-11055, band casting method or the like. The latter cellulose acylate film composed of a plurality of layers is formed by a so-called cocasting method disclosed in JP-A-61-94725 and JP-B-62-43846. In some detail, the cocasting method comprises dissolving a raw material flake in a solvent such as halogenated hydrocarbon (e.g., dichloromethane), alcohol (e.g., methanol, ethanol, butanol), ester (e.g., methyl formate, methyl acetate) and ether (e.g., dioxane, dioxolane, diethyl ether), optionally adding various additives such as plasticizer, ultraviolet absorber, deterioration inhibitor, lubricant and exfoliation accelerator to the solution to prepare a solution (referred to as “dope”), casting the dope over a support composed of a horizontal endless metallic belt or a rotary drum in a single layer if a single-layer film is formed or simultaneously in a plurality of layers comprising a low concentration dope on the both sides of a high concentration cellulose ester dope if a multi-layer film is formed, drying the cast on the support to some extent, peeling the film thus provided with rigidity off the support, and then passing the film through a drying zone by various conveying means to remove the solvent therefrom.

Representative examples of the aforementioned solvent for dissolving cellulose acylate include dichloromethane. However, the solvent is preferably substantially free of halogenated hydrocarbon such as dichloromethane from the standpoint of global environment or working atmosphere. The term “substantially free of halogenated hydrocarbon” as used herein is meant to indicate that the proportion of halogenated hydrocarbon in the organic solvent is less than 5% by mass (preferably less than 2% by mass).

For the details of the aforementioned various cellulose acylate films (film made of triacetyl cellulose) and method of preparing thereof, reference can be made to Japan Institute of Invention and Innovation's Kokai Giho No. 2001-1745, issued on Mar. 15, 2001.

The thickness of the cellulose acylate film is preferably from 40 μm to 120 μm. Taking into account handleability, coatability, etc., the thickness of the cellulose acylate film is preferably about 80 μn. However, from the standpoint of tendency toward the reduction of the thickness of polarizing plate accompanying the recent demand for the reduction of the thickness of display devices, the thickness of the cellulose acylate film is preferably from about 40 μm to 60 μm. In the case where such a thin cellulose acylate film is used as a transparent support for the anti-reflection film of the invention, it is desirable that the aforementioned problems with handleability, coatability, etc. be solved by optimizing the solvent to be incorporated in the coating solution to be directly spread over the cellulose acetate film, the thickness of the coating layer, the percent crosslink shrinkage of the coating layer, etc.

<Other Layers>

Examples of other layers which may be provided interposed between the transparent support and the light-scattering layer of the invention include antistatic layer (to be provided in the case where there are requirements that the surface resistivity on the display side be reduced or in the case where the attachment of dust to the surface raises a problem), moistureproof layer, adhesion improving layer, and rainbow (interference) preventive layer.

These layers can be formed by known methods.

The light-scattering film of the invention can be formed by the following method, but the invention is not limited thereto.

[Preparation of Coating Solution]

Firstly, a coating solution containing components constituting the various layers is prepared. During this procedure, the rise of the water content in the coating solution can be inhibited by minimizing the evaporation loss of the solvent. The water content in the coating solution is preferably 5% or less, more preferably 2% or less. The inhibition of the evaporation loss of the solvent is accomplished by improving the airtightness of the tank during the agitation of the various materials which have been put therein or minimizing the contact area of the coating solution with respect to air during the movement of the coating solution. Alternatively, a unit of reducing the water content in the coating solution may be provided during or before and after spreading.

The coating solution for forming the light-scattering layer is preferably filtered such that foreign matters having a size corresponding to the dry thickness (about 50 nm to 120 nm) of the low refractive layer to be formed directly on the light-scattering layer can be removed substantially completely (90% or more). Since the light-transmitting particulate material for providing light diffusivity has a thickness equal to or greater than that of the low refractive layer, the aforementioned filtration is preferably conducted on the intermediate solution comprising all materials other than light-transmitting particulate material incorporated therein. In the case where no filters which can remove the aforementioned foreign matters having a small particle diameter are available, filtration is preferably conducted such that foreign matters having a size corresponding to the wet thickness (about from 1 to 10 μm) of the layer to be directly formed on the light-scattering layer can be removed substantially completely. In these manners, point defects of the layer formed directly on the light-scattering layer can be eliminated.

[Coating]

Subsequently, the coating solution for forming the light-scattering layer and optionally the low refractive layer is spread over the surface of a web as a transparent support which is continuously running by an extrusion method (die coating method), and then heated and dried. Thereafter, the coating layer is irradiated with light rays and/or heated to cause the polymerization and curing of the monomer for forming light-scattering layer or low refractive layer. In this manner, a light-scattering layer and a low refractive layer are formed. The light-scattering layer may be composed of a single layer or a plurality of layers, e.g., two to four layers. The light-scattering layer may be provided on the transparent support directly or with other layers such as antistatic layer and moistureproof layer provided interposed therebetween.

In general, extrusion method (die coating method) is preferably used from the standpoint of production rate. A die coater which is preferably used in an area having a small wet spread (20 cc/m² or less) as in the light-scattering layer or anti-reflection film of the invention will be described hereinafter.

<Configuration of Die Coater>

FIG. 2 is a sectional view of a coater comprising a slot die used in the implementation of the invention. A coater 10 is adapted to spread a coating solution 14 from a slot die 13 in the form of bead 14a over a web W which is continuously running while being supported on a backup roller 11 to form a coating layer 14b on the web W.

Formed inside the slot die 13 are a pocket 15 and a slot 16. The pocket 15 has a section formed by a curve and a straight line. The section may be substantially circular as shown in FIG. 2 or semicircular. The pocket 15 is a coating solution reservoir space extending in the crosswise direction of the slot die 13 with its sectional shape. The effective length of extension of the space is normally equal to or somewhat longer than the coating width. The supply of the coating solution 14 into the pocket 15 is conducted on the side of the slot die 13 or on the center of the side of the slot die 13 opposite the slot opening 16a. The pocket 15 comprises a plug provided therein for preventing the leakage of the coating solution 14.

The slot 16 is a channel for the coating solution 14 from the pocket 15 to the web W. The channel has a sectional shape extending in the crosswise direction of the slot die 13 as in the pocket 15. The width of the opening 16a disposed on the web side of the channel is normally adjusted to a value substantially equal to the coating width by a width limiting plate (not shown). The angle of the forward end of the slot 16 with respect to the line normal to the surface of the backup roller 11 in the web running direction is preferably from not smaller than 30° to not greater than 90°.

The forward end lip 17 of the slot die 13 at which the opening 16a of the slot 16 is disposed is convergent. The forward end of the lip 17 forms a flat portion 18 called land. In the land 18, the portion disposed upstream from the slot 16 along the running direction of web W is called upstream lip land 18a. The portion disposed downstream from the slot 16 along the running direction of web W is called downstream lip land 18b.

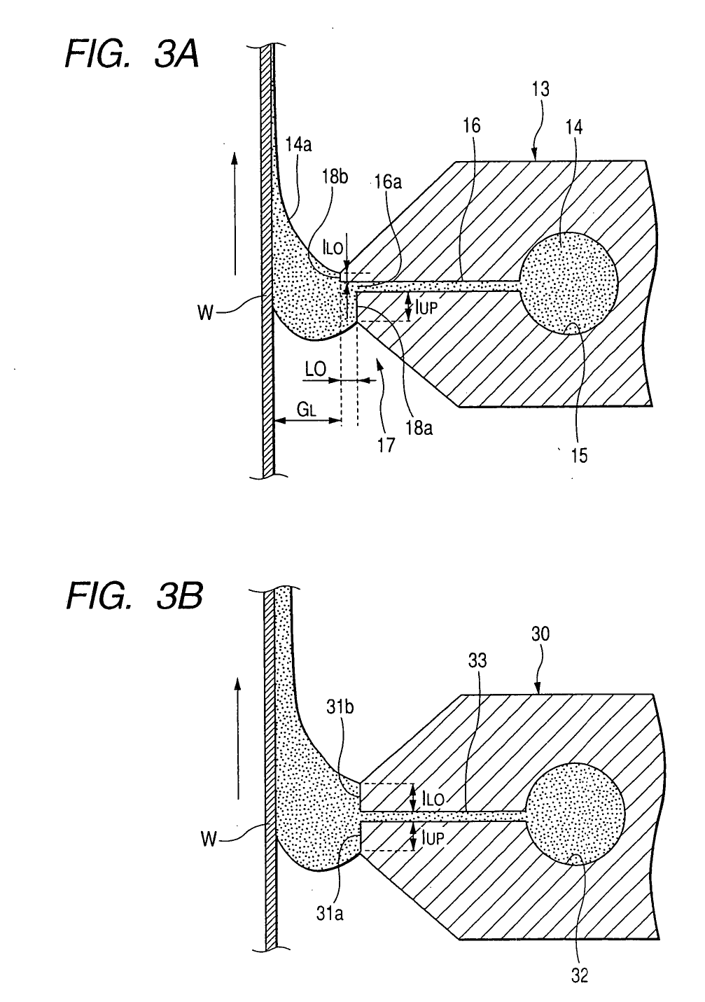

FIG. 3 illustrates the sectional shape of the slot die 13 as compared with the related art. FIG. 3A illustrates the slot die 13 of the invention. FIG. 3B illustrates a related art slot die 30. In the related art slot die 30, the distance between the upstream lip land 31a and the web W and the distance between the downstream lip land 31b and the web W are the same as each other. In FIG. 3B, the reference numeral 32 indicates a pocket and the reference numeral 33 indicates a slot. In the slot die 13 of the invention, on the contrary, the length I_{LO} of the downstream lip land is shorter than the length of the upstream lip land. In this arrangement, spreading can be conducted to a wet thickness of 20 μm or less with a good precision. Even when the wet thickness is 20 μm or more, the surface conditions of the coating layer can be further improved.

The length I_{UP} of the upstream lip land 18a is not specifically limited but is preferably from 500 μm to 1 mm. The length I_{LO} of the downstream lip land 18b is from not smaller than 30 μm to not greater than 100 μm, preferably from not smaller than 30 μm to not greater than 80 μm, more preferably from not smaller than 30 μm to not greater than 60 μm. When the length I_{LO} of the downstream lip land is less than 30 μm, the edge or land of the forward lip can easily break off, making it easy to cause the occurrence of streak on the coating layer and hence making spreading impossible. Another problem arises that the wet line position on the downstream side can be difficulty predetermined, making it easy for the coating solution to spread on the downstream side. It has heretofore been known that the expansion of wet by the coating solution on the downstream side means unevenness in wet line and results in the occurrence of defective shapes such as streak on the coating layer. On the contrary, when the length I_{LO} of the downstream lip land is more than 100 μm, the bead itself cannot be formed, making it impossible to make thin layer spreading.

Further, the downstream lip land 18b has an overbite configuration such that it is disposed closer to the web W than the upstream lip land 18a. In this arrangement, the degree of vacuum can be reduced to form a bead suitable for thin layer spreading. The difference in distance from the web W between the downstream lip land 18b and the upstream lip land 18a (hereinafter referred to as “overbite length LO”) is preferably from not smaller than 30 μm to not greater than 120 μm, more preferably from not smaller than 30 μm to not greater than 100 μm, most preferably from not smaller than 30 μm to not greater than 80 μm. When the slot die 13 has an overbite configuration, the gap G_{L} between the forward end lip 17 and the web W indicates the gap between the downstream lip land 18b and the web W.

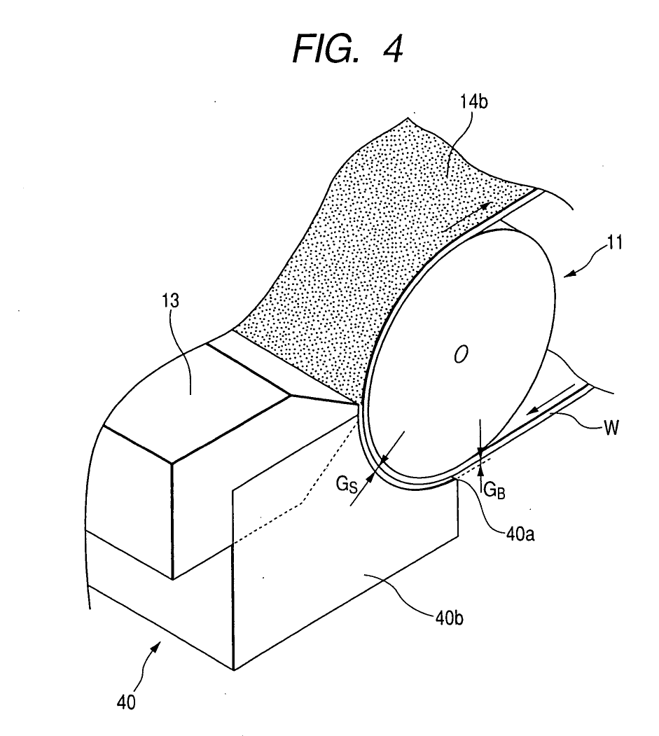

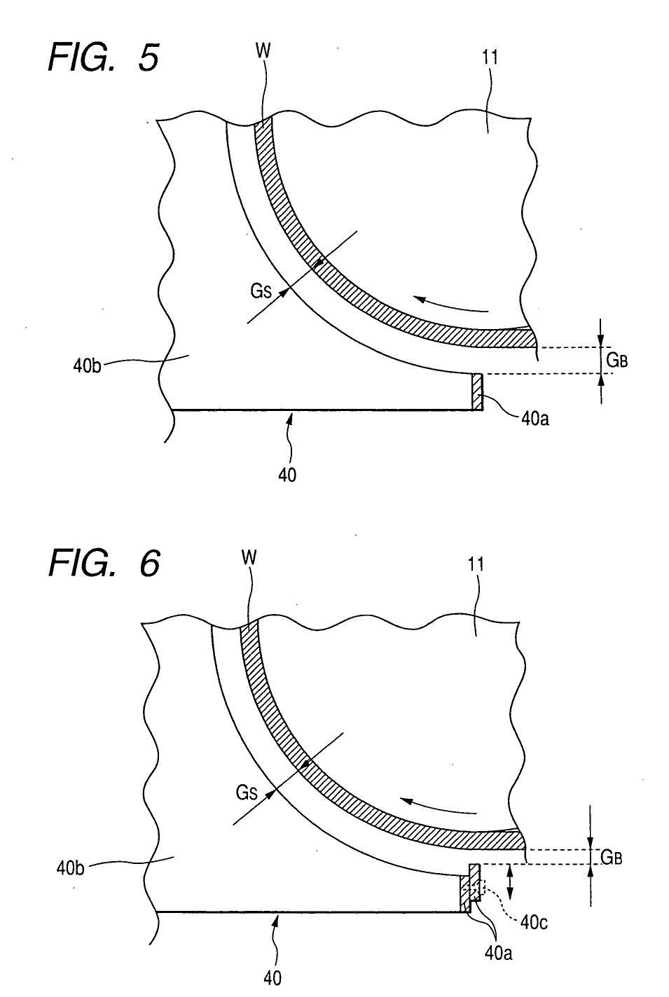

FIG. 4 is a perspective view illustrating a slot die used at the coating step in the implementation of the invention and its periphery. Disposed on the side of the slot die opposite the side on which the web W is running is a pressure-reducing chamber 40 at a position where it doesn't come in contact with the slot die such that sufficient adjustment of pressure reduction can be made on the bead 14a. The pressure-reducing chamber 40 comprises a back plate 40a and a side plate 40b for maintaining the operating efficiency. There are present gaps G_{B} and G_{S} between the back plate 40a and the web W and between the side plate 40b and the web W, respectively. FIGS. 5 and 6 each are a sectional view illustrating the pressure-reducing chamber 40 and the web W which are disposed close to each other. The side plate and the back plate may be formed integral with the chamber as shown in FIG. 5 or may be fixed to the chamber 40 with a screw 40c so that the gap can be properly varied as shown in FIG. 6. Regardless of the configuration, the actual space between the back plate 40a and the web W and between the side plate 40b and the web W are defined to be G_{B} and G_{S}, respectively. The gap G_{B} between the back plate 40a and the web W in the pressure-reducing chamber 40 indicates the gap between the uppermost end of the back plate 40a and the web W in the case where the pressure-reducing chamber 40 is disposed beneath the web W and the slot die 13 as shown in FIG. 4.

The arrangement is preferably made such that the gap G_{B} between the back plate 40a and the web W is larger than the gap G_{L} between the forward end lip 17 of the slot die 13 and the web W. In this arrangement, the change of the degree of vacuum in the vicinity of bead attributed to the eccentricity of the backup roller 11 can be inhibited. For example, when the gap G_{L} between the forward end lip 17 of the slot die 13 and the web W is from not smaller than 30 μm to not greater than 100 μm, the gap G_{B} between the back plate 40a and the web W is preferably predetermined to be from not smaller than 100 μm to not greater than 500 μm.

[Material, Precision]

As the length of the forward end lip in the web running direction on the web W running side increases, it is less advantageous for the formation of bead. When the length of the forward end lip varies with arbitrary sites in the crosswise direction of the slot die, the resulting slight external disturbance makes the bead unstable. Accordingly, the change of the length of the forward end lip in the crosswise direction of the slot die is preferably predetermined to be 20 μm or less.

Referring to the material of the forward end lip of the slot die, a material such as stainless steel undergoes sagging during die machining, making it impossible to satisfy the desired precision of the forward end lip even if the length of the forward end lip of the slot die is from 30 to 100 μm in the web running direction as previously mentioned. Accordingly, in order to maintain a high working precision, it is important to use an ultrahard material as disclosed in Japanese Patent No. 2,817,053. In some detail, at least the forward end lip of the slot die is preferably made of an ultrahard alloy comprising carbide crystals having an average particle diameter of 5 μm or less bonded thereto. Examples of the ultrahard alloy include those obtained by bonding carbide crystallites such as tungsten carbide (hereinafter referred to as “WC”) with a binding metal such as cobalt. As the binding metal there may be used titanium, tantalum, niobium or mixture thereof besides cobalt. The average particle diameter of WC crystallites is more preferably 3 μm or less.

In order to realize a high resolution spreading, the aforementioned length of the forward end lip on the side where the web is running and the dispersion of the gap between the forward end lip and the web in the crosswise direction of the slot die, too, are important factors. The combination of the two factors, i.e., straightness such that the change of gap can be somewhat inhibited is preferably attained. More preferably, the straightness of the forward end lip with respect to the backup roller is attained such that the change of the gap in the crosswise direction of the slot die is not greater than 5 μm.

<Coating Speed>

By attaining the aforementioned precision of the backup roll and forward end lip, the coating method which is preferably used in the invention can provide a coating layer having a stable thickness during high speed spreading. Further, since the coating method of the invention involves premeasurement process, a coating layer having a stable thickness can be easily assured even during high speed spreading. For the coating solution to be spread in a small amount as in the anti-reflection film of the invention, the coating method of the invention allows a high speed spreading with a good stability of layer thickness. Other coating methods allow spreading. However, dip coating method unavoidably requires the oscillation of the coating solution in the liquid receiving tank, causing the occurrence of stepwise unevenness. Reverse roll coating method and microgravure coating method can easily cause the occurrence of stepwise unevenness due to eccentricity or deflection of the roll related to spreading. Microgravure coating method can easily cause the occurrence of spread unevenness due to the preparation precision of the gravure roll or the change of the roll or blade with time due to contact of the blade with the gravure roll. Since these coating methods involve postmeasurement process, a stable layer thickness can be difficulty assured. The preparation method of the invention is preferably used to spread the coating solution at a rate of 25 m/min from the standpoint of productivity.

<Wet Spread>

In order to form the light-scattering layer, the aforementioned coating solution is preferably spread over the substrate film directly or with the interposition of other layers to a wet thickness of from 6 to 30 μm. The wet thickness is preferably from 3 to 20 μm from the standpoint of prevention of drying unevenness. Further, in the case where a low refractive layer is formed, the coating compositions is preferably spread over the light-scattering layer directly or with the interposition of other layers to a wet thickness of from 1 to 10 μm, more preferably from 2 to 5 μm.

[Drying]

The coating solution of light-scattering layer and low refractive layer which have been spread over the substrate film directly or with the interposition of other layers (indirectly) is then conveyed over the web to a heated zone so that it is dried to remove the solvent. During this procedure, the temperature of the drying zone is preferably from 25° C. to 140° C. The former half of the drying zone preferably has a relatively low temperature. The latter half of the drying zone preferably has a relatively high temperature. However, the temperature of the drying zone is preferably not higher than the temperature at which the components other than the solvent contained in the coating composition of the various layers begin to evaporate. For example, some of the commercially available photoradical generators to be used in combination with the ultraviolet-curing resin evaporate in an amount of several 10 percentage in several minutes in a 120° C. hot air flow. Some monofunctional or bifunctional acrylate monomers undergo evaporation in a 100° C. hot air flow. In this case, the temperature of the drying zone is preferably a temperature at which the components other than the solvent contained in the coating composition of the various layers begin to evaporate as previously mentioned.

The drying air to be used after the spreading of the coating composition of the various layers over the substrate film flows preferably at a rate of from 0.1 to 2 m/sec over a zone having a solid content concentration of from 1 to 50% to prevent the occurrence of drying unevenness. However, some coating compositions may be preferably dried at a higher rate.

After the spreading of the coating composition of the various layers over the substrate film, the difference in temperature between the conveying roll in contact with the side of the substrate film opposite the coated surface thereof and the substrate film in the drying zone is preferably from 0° C. to 20° C. so that the occurrence of drying unevenness due to heat conduction unevenness on the conveying roll can be prevented.

[Curing]

The various coating layers which have passed through the solvent drying zone are then passed through a zone for curing the web by a method involving irradiation with ionizing radiation and/or heating. For example, in the case where the coating layer is ultraviolet-curing, the coating layer is preferably irradiated with ultraviolet rays from an ultraviolet lamp at a dose of from 10 mJ/cm² to 1,000 mJ/cm² so that it is cured. During this procedure, the distribution of dose over the range between the two ends in the crosswise direction of web preferably shows a proportion of from 50% to 100%, more preferably from 80% to 100% based on the central maximum dose. In the case where it is necessary that the oxygen concentration be reduced by purging with nitrogen gas or the like to accelerate surface curing, the oxygen concentration is preferably 0.01% to 5%. Referring to the crosswise distribution, the proportion of oxygen concentration is preferably 2% or less.

In the case where the percent curing (100−content of functional group residue) of the light-scattering layer is a value of less than 100%, when the percent curing of the light-scattering layer after the curing of a low refractive layer of the invention thereon by irradiation with ionizing radiation and/or application of heat is higher than that developed before the provision of the low refractive layer, the adhesion between the light-scattering layer and the low refractive layer can be improved to advantage.

The light-scattering film and anti-reflection film of the invention thus produced can be used to prepare a polarizing plate which is then used in a liquid crystal display device. In this case, the polarizing plate is disposed on the outermost surface of the display with an adhesive layer provided on one side thereof. The anti-reflection film of the invention is preferably used as at least one of two sheets of protective film between which the polarizing film in the polarizing plate is interposed.

The anti-reflection film of the invention can also act as a protective film to reduce the production cost of the polarizing plate. Further, the anti-reflection film of the invention can be used as an outermost layer to prevent the reflection of external light rays, etc., making it possible to provide a polarizing plate excellent also in scratch resistance, stainproofness, etc.

In order to use the light-scattering layer or anti-reflection film of the invention as one of two sheets of surface protective film for polarizing plate to prepare a polarizing plate, the anti-reflection film is preferably subjected to hydrophilicization on the side of the transparent support opposite the anti-reflection structure, i.e., on the side thereof where it is stuck to the polarizing film to improve the adhesion of the adherend surface thereof.

[Saponification]

(1) Alkaline Solution Dipping Method

This is a method which comprises dipping the light-scattering layer or anti-reflection film in an alkaline solution under proper conditions to saponify the entire surface of the film having reactivity with alkali. This method is advantageous in cost because it requires no special facilities. The alkaline solution is preferably an aqueous solution of sodium hydroxide. The concentration of the alkaline solution is preferably from 0.5 to 3 mol/l, particularly from 1 to 2 mol/l. The temperature of the alkaline solution is preferably from 30° C. to 75° C., particularly from 40° C. to 60° C.

The aforementioned combination of saponifying conditions is preferably a combination of relatively mild conditions but can be predetermined by the material and configuration of the light-scattering film or anti-reflection film and the target contact angle.

It is preferred that the light-scattering film or anti-reflection film which has been dipped in the alkaline solution be thoroughly washed with water or dipped in a dilute acid to neutralize the alkaline component so that the alkaline component is not left in the film.

When the light-scattering film or anti-reflection film is saponified, the transparent support is hydrophilicized on the side thereof opposite the light-scattering film or anti-reflection layer. The protective film for polarizing plate is used in such an arrangement that the hydrophilicized surface of the transparent support comes in contact with the polarizing film.

The hydrophilicized surface of the transparent support is effective for the improvement of the adhesion to the adhesive layer mainly composed of polyvinyl alcohol.

Referring to saponification, the contact angle of the surface of the transparent support on the side thereof opposite the light-scattering layer or low refractive layer with respect to water is preferably as small as possible from the standpoint of adhesion to the polarizing film. On the other hand, since the dipping method is subject to damage by alkali even on the surface of the transparent support on the light-scattering layer or low refractive layer side thereof, it is important to use minimum required reaction conditions. In the case where as an index of damage of light-scattering layer by alkali there is used the contact angle of the surface of the transparent support on the side thereof opposite the light-scattering layer, the contact angle is preferably from 100 to 50°, more preferably from 30° to 50°, even more preferably from 40° to 50°, if the support is a triacetyl cellulose film in particular. When the contact angle is 50° or more, there arises a problem with contact with the polarizing film to disadvantage. On the contrary, when the contact angle is less than 10°, the resulting anti-reflection layer undergoes too much damage and is subject to loss of physical strength to disadvantage.

(2) Alkaline Solution Coating Method

As a method of avoiding the damage of the various layers in the aforementioned dipping method there is preferably used an alkaline solution coating method which comprises spreading an alkaline solution only over the surface of the transparent support on the side thereof opposite the light-scattering layer or anti-reflection layer, and heating, rinsing and drying the coating layer under proper conditions. The term “spreading” as used herein is meant to indicate that the alkaline solution or the like comes in contact with only the surface of the transparent support to be saponified. Besides spreading, spraying and contact with a belt or the like impregnated with an alkaline solution are included. Since the use of these methods requires the provision of separate facilities and steps for spreading the alkaline solution, this method is inferior to the dipping method (1) from the standpoint of cost. However, since the coating method involves the contact with only the surface of the transparent support to be saponified, it is advantageous in that the opposite side of the transparent support can be made of a material which is easily affected by alkaline solution. For example, the vacuum deposit or sol-gel layer is subject to various effects such as corrosion, dissolution and exfoliation by alkaline solution and is preferably not formed by the dipping method but may be formed by the coating method without any problems because it requires no contact with the alkaline solution.

Both the aforementioned saponification methods (1) and (2) can be conducted after the formation of the various layers on the support unwound from the roll. Therefore, these saponification methods can be each conducted as a continuous step following the aforementioned step of producing the light-scattering film or anti-reflection film. Further, by subsequently conducting the step of sticking the film to a polarizing film of continuous length unwound, the polarizing plate can be prepared more efficiently than the similar process conducted in the form of sheet.

(3) Method which Comprises Saponifying Light-Scattering Film or Anti-Reflection Film Protected by Laminate Film

In the case where the light-scattering layer and/or low refractive layer has an insufficient resistance to alkaline solution as in the aforementioned method (2), a method may be effected which comprises laminating the final layer thus formed with a laminate film on the final layer side thereof, dipping the laminate in an alkaline solution to hydrophilicize only the triacetyl cellulose side, which is opposite the final layer side, and then peeling the laminate film off the light-scattering layer. In accordance with this method, too, hydrophilicization required only for protective film for polarizing plate can be made on only the side of the triacetyl cellulose film opposite the final layer without any damage on the light-scattering layer and low refractive layer. As compared with the aforementioned method (2), the method (3) involves the disposal of the laminate film but is advantageous in that it requires no special apparatus for spreading an alkaline solution.

(4) Method which Comprises Dipping the Laminate in an Alkaline Solution After the Formation of Light-Scattering Layer

In the case where the laminate is resistant to an alkaline solution up to the light-scattering layer but the low refractive layer is insufficiently resistant to an alkaline solution, the laminate may be dipped in an alkaline solution after the formation of the light-scattering layer so that the both sides thereof are hydrophilicized, followed by the formation of the low refractive layer on the light-scattering layer. This method requires complicated productions steps but is advantageous in that the adhesion between the light-scattering layer and the low refractive layer can be enhanced if the low refractive layer is a layer having a hydrophilic group such as fluorine-containing sol-gel layer.

(5) Method which Comprises Forming a Light-Scattering Film or Anti-Reflection Film on a Saponified Triacetyl Cellulose Film

A light-scattering layer and a low refractive layer may be formed on any one side of a triacetyl cellulose film which has been previously saponified by dipping in an alkaline solution directly or with other layers interposed therebetween. When the triacetyl cellulose film is dipped in an alkaline solution to undergo saponification, the adhesion between the light-scattering layer or other layers and the triacetyl cellulose film which has been hydrophilicized by saponification can be deteriorated. In this case, the triacetyl cellulose film which has been saponified may be subjected to treatment such as corona discharge and glow discharge only on the side thereof where the light-scattering layer or other layers are formed so that the hydrophilicized surface can be removed before the formation of the hard coating layer or other layers. Further, in the case where the hard coating layer or other layers have a hydrophilic group, the interlayer adhesion may be good.

A polarizing plate comprising the light-scattering film or anti-reflection film of the invention and a liquid crystal display device comprising the polarizing plate will be described hereinafter.

[Polarizing Plate]

A preferred polarizing plate of the invention has a light-scattering film or anti-reflection film of the invention as at least one of the protective films for polarizing film (polarizing plate protective film). The polarizing plate protective film preferably has a contact angle of from 10° to 50° with respect to water on the surface of the transparent support opposite the light-scattering layer or anti-reflection layer, i.e., on the side thereof where it is stuck to the polarizing film as previously mentioned.

The use of the light-scattering film or anti-reflection film of the invention as a protective film for polarizing plate makes it possible to prepare a polarizing plate having a light-scattering or anti-reflection capacity excellent in physical strength and light-resistance and drastically reduce the cost and thickness of display device.

Further, the constitution of a polarizing plate comprising a light-scattering film or anti-reflection film of the invention as one protective film for polarizing plate and an optical compensation film having an optical anisotropy described later as the other protective film for polarizing film makes it possible to prepare a polarizing plate that provides a liquid crystal display device with an improved contrast in the daylight and a drastically raised horizontal and vertical viewing angle.

[Optical Compensation Layer]

The polarizing plate may comprise an optical compensation layer (retarder layer) incorporated therein to improve the viewing angle properties of a liquid crystal display screen.

As the optical compensation layer there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support.

This angle preferably changes with the rise of the distance from the transparent support side of the optically anisotropic layer composed of discotic compound.

In the case where the optical compensation layer is used as a protective film for polarizing film, the optical compensation layer is preferably saponified on the side thereof on which it is stuck to the polarizing film. The saponification of the optical compensation layer is preferably conducted in the same manner as mentioned above.

[Polarizing Film]

As the polarizing film there may be used a known polarizing film or a polarizing film cut out of a polarizing film of continuous length having an absorption axis which is neither parallel to nor perpendicular to the longitudinal direction. The polarizing film of continuous length having an absorption axis which is neither parallel to nor perpendicular to the longitudinal direction is prepared by the following method.

This is a polarizing film stretched by tensing a continuously supplied polymer while being retained at the both ends thereof by a retainer. In some detail, the polarizing film can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs [0020]-[0030].

[Image Display Device]

The light-scattering film prepared by the production method of the invention can be applied to image display devices such as liquid crystal display device (LCD), plasma display panel (PDP), electroluminescence (ELD), cathode ray tube display device (CRT), electric field emission display (FED) and surface electric field display (SED), particularly to liquid crystal display device (LCD).

<Image Display Device>

The light-scattering film or anti-reflection film prepared by the production method of the invention can be applied to image display devices such as liquid crystal display device (LCD), plasma display panel (PDP), electroluminescence (ELD), cathode ray tube display device (CRT), electric field emission display (FED) and surface electric field display (SED), particularly to liquid crystal display device (LCD).

<Liquid Crystal Display Device>

The anti-reflection film of the invention, if used as one of polarizing film surface protective films, is preferably used in transmission type, reflection type or semi-transmission type liquid crystal display devices of mode such as twisted nematic (TN), supertwisted nematic (STN), vertical alignment (VA), in-plane switching (IPS) and optically compensated bend cell (OCB).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high response.

In ECB mode liquid crystal cell, rod-shaped liquid crystal molecules are oriented substantially horizontal when no voltage is applied thereto. The ECB mode liquid crystal cell is used mostly as a color TFT liquid crystal display device. For details, reference can be made to many literatures, e.g., “EL, PDP, LCD Displays”, Toray Research Center, 2001.

For TV or IPS mode liquid crystal display devices in particular, the use of an optical compensation sheet having a viewing angle expanding effect as one of two sheets of polarizing film protective film opposite the anti-reflection film of the invention makes it possible to obtain a polarizing plate having both anti-reflection effect and viewing angle expanding effect by the thickness of only one sheet of polarizing plate as disclosed in JP-A-2001-100043.

### EXAMPLE

The invention will be further described in the following examples, but the invention is not limited thereto. The terms “parts” and “%” as used hereinafter are by mass unless otherwise specified.
(Synthesis of Perfluoroolefin Copolymer (1))

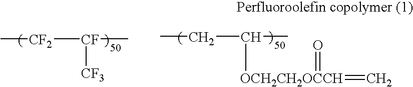

(The figure (50:50) indicates molar ratio)

In a 100 ml stainless steel autoclave with stirrer were charged 40 ml of ethyl acetate, 14.7 g of hydroxyethyl vinyl ether and 0.55 f of dilauroyl peroxide. The air in the system was evacuated and replaced by nitrogen gas. 25 g of hexafluoropropylene (HFP) was then introduced into the autoclave which was then heated to 65° C. The pressure in the autoclave developed when the temperature in the autoclave reached 65° C. was 0.53 MPa (5.4 kg/cm²). The temperature in the autoclave was then kept at 65° C. where the reaction was continued for 8 hours. When the pressure in the autoclave reached 0.31 MPa (3.2 kg/cm²), heating was suspended so that the autoclave was allowed to cool. When the internal temperature of the autoclave reached to room temperature, the unreacted monomers were then removed. The autoclave was then opened to withdraw the reaction solution. The reaction solution thus obtained was then poured into a large excess of hexane. By removing the solvent by decantation, the precipitated polymer was withdrawn. The polymer thus obtained was dissolved in a small amount of ethyl acetate. The solution was then twice reprecipitated from hexane to remove thoroughly the residual monomers. After dried, a polymer was obtained in an amount of 28 g. Subsequently, 20 g of the polymer thus obtained was dissolved in 100 ml of N,N-dimethylacetamide. To the solution was then added dropwise 11.4 g of acrylic acid chloride under ice cooling. The mixture was then stirred at room temperature for 10 hours. To the reaction solution was then added ethyl acetate. The reaction solution was then washed with water. The organic phase was then extracted. The residue was then concentrated. The polymer thus obtained was then reprecipitated from hexane to obtain 19 g of a perfluoroolefin copolymer (1) having the following structure which is a functional fluorine-containing polymer. The refractive index of the polymer thus obtained was 1.421.

(Preparation of Sol A)

Into a reaction vessel equipped with an agitator and a reflux condenser were charged 120 parts by mass of methyl ethyl ketone, 100 parts by mass of acryloyl oxypropyl trimethoxysilane “KBM-5103” (produced by Shin-Etsu Chemical Co., Ltd.) and 3 parts by mass of diisopropoxy aluminum ethyl acetoacetate. The mixture was then stirred. To the mixture were then added 30 parts by mass of deionized water. The reaction mixture was allowed to undergo reaction at 60° C. for 4 hours, and then allowed to cool to room temperature to obtain a sol a. The compound thus obtained had a mass-average molecular mass of 1,600. The proportion of components having a molecular mass of from 1,000 to 20,000 in the oligomer components or high components was 100%. The gas chromatography of the reaction product showed that none of the acryloyloxy propyl trimethoxysilane as raw material remained.

(Preparation of Sol B)

A sol b was obtained in the same manner as in the sol a except that the cooling of the reaction solution to room temperature was followed by the addition of 6 parts of acetyl acetone.

(Preparation of Coating Solution for Light-Scattering Layer A)

50 g of a mixture of pentaerythritol triacrylate and pentaerythritol tetraacrylate (PET-30, produced by NIPPON KAYAKU CO., LTD.) was diluted with 40 g of toluene. To the solution was then added 2 g of a photopolymerization initiator (Irgacure 184 (produced by Ciba Specialty Chemicals Co., Ltd.)). The mixture was then stirred. This solution was spread and dried, and then ultraviolet-cured to obtain a coating layer having a refractive index of 1.51.

To the solution were then added 1.7 g of a 30% toluene dispersion of crosslinked polystyrene particles having an average particle diameter of 3.5 μm (refractive index: 1.61; SX-350, produced by Soken Chemical & Engineering Co., Ltd.) which had been subjected to dispersion at 10,000 rpm using a polytron dispersing machine for 20 minutes and 13.3 g of a 30% toluene dispersion of crosslinked acryl-styrene particles having an average particle diameter of 3.5 μm (refractive index: 1.55; produced by Soken Chemical & Engineering Co., Ltd.). To the solution were then added 0.75 g of a fluorine-based surfactant (FP-149) and 10 g of a silane coupling agent (KBM-5103, produced by Shin-Etsu Chemical Co., Ltd.) to complete the desired solution.

The aforementioned mixture was then filtered through a polypropylene filter having a pore diameter of 30 μm to prepare a light-scattering layer coating solution A.

The liquid density of the coating solution was 0.99. The density of light-transmitting particulate material was 1.06. Accordingly, (σ−ρ)×d² was 0.86.

(Preparation of Coating Solution for Light-Scattering Layer B)

285 g of a commercially available zirconia-containing UV-curing hard coat solution (DeSolite Z7404, produced by JSR Co., Ltd.; solid content concentration: approx. 61%; ZrO2 content in solid content: approx. 70%; polymerizable monomer; polymerization initiator contained) and 85 g of a mixture of dipentaerythritol pentaacrylate and dipentaerythritol hexaacrylate (DPHA, produced by NIHON KAYAKU CO., LTD.) were mixed. The mixture was then diluted with 60 g of methyl isobutyl ketone and 17 g of methyl ethyl ketone. To the mixture was then added 28 g of a silane coupling agent (KBM-5103, produced by Shin-Etsu Chemical Co., Ltd.). The mixture was then stirred. The solution thus prepared was spread and dried, and then ultraviolet-cured to obtain a coating layer having a refractive index of 1.61.

To the solution was then added 34 g of a dispersion obtained by dispersing a 30% methyl isobutyl ketone dispersion of a classified reinforced crosslinked particulate PMMA having an average particle diameter of 3.0 μm (refractive index: 1.49; MXS-300, produced by Soken Chemical & Engineering Co., Ltd.) at 10,000 rpm by a polytron dispersing machine for 20 minutes. Subsequently, to the mixture were added 90 g of a dispersion obtained by dispersing a 30% methyl ethyl ketone dispersion of a particulate silica having an average particle diameter of 1.5 μm (refractive index: 1.46, SEAHOSTER KE-P150, produced by NIPPON SHOKUBAI CO., LTD.) at 10,000 rpm by a polytron dispersing machine for 30 minutes and finally 0.12 g of a fluorinated surfactant (FP-1). The mixture was then stirred to complete the desired solution.

The aforementioned mixture was filtered through a polypropylene filter having a pore diameter of 30 μm to prepare a light-scattering layer coating solution B.

The liquid density of the coating composition was 1.15. Referring to the density of the light-transmitting particulate material, the density of PMMA and silica were 1.18 and 2.0, respectively. However, PMMA swelled with the solvent in the coating composition to rise in the average particle diameter by about 30%. Thus, the apparent density of PMMA was 1.17. Accordingly, (σ−ρ)×d² was 0.30 for PMMA and 1.91 for silica.

(Preparation of Coating Solution for Light-Scattering Layer C)

A light-scattering layer coating solution C was prepared in the same manner as in the light-scattering layer coating solution B, including the added amount, except that 120 g of a 30% methyl ethyl ketone dispersion of a classified reinforced crosslinked particulate PMMA having an average particle diameter of 1.5 μm (MXS-150H; crosslinking agent; ethylene glycol dimethacrylate; amount of crosslinking agent: 30%; produced by Soken Chemical & Engineering Co., Ltd.; refractive index: 1.49) was used instead of the particulate silica having an average particle diameter of 1.5 μm.

The liquid density of the coating composition thus prepared was 1.15. The density of the light-transmitting particulate material was 1.18. However, since the light-transmitting particulate material swelled with the solvent in the coating composition to raise the average particle diameter thereof by about 30%, it showed an apparent density of 1.17. Accordingly, (σ−ρ)×d² was 0.076 for particulate material having a particle diameter of 1.5 μm and 0.30 for particulate material having a particle diameter of 3 μm.

(Preparation of Coating Solution for Low Refractive Layer A)

15 g of a heat-crosslinkable fluorine-containing polymer having a refractive index of 1.42 containing a polysiloxane and a hydroxyl group (JN7228A; solid content concentration: 6%; produced by JSR Co., Ltd.), 0.6 g of silica sol (silica; MEK-ST; average particle diameter: 15 nm; solid content concentration: 30%; produced by NISSAN CHEMICAL INDUSTRIES, LTD.), 0.8 g of silica sol (silica; same as MEK-ST except for particle size; average particle diameter: 45 nm; solid content concentration: 30%; produced by NISSAN CHEMICAL INDUSTRIES, LTD.), 0.4 g of sol a, 3 g of methyl ethyl ketone and 0.6 g of cyclohexanone were mixed with stirring. The mixture was then filtered through a polypropylene filter having a pore diameter of 1 μm to prepare a low refractive layer coating solution A. The layer formed by the coating solution showed a refractive index of 1.43.

(Preparation of Low Refractive Layer Coating Solution B)

A low refractive layer coating solution B was prepared in the same manner as in the low refractive layer coating solution A, including the added amount, except that 1.95 g of a hollow silica sol (refractive index: 1.31; average particle diameter: 60 nm; solid content concentration: 20%) was used instead of silica sol. The layer formed by the coating solution showed a refractive index of 1.38.

(Preparation of Coating Solution for Low Refractive Layer C)

15.2 g of a perfluoroolefin copolymer (1), 1.4 g of silica sol (silica; same as MEK-ST except for particle size; average particle diameter: 45 nm; solid content concentration: 30%; produced by NISSAN CHEMICAL INDUSTRIES, LTD.), 0.3 g of a reactive silicone X-22-164B (trade name: produced by Shin-Etsu Chemical Co., Ltd.), 7.3 g of sol a, 0.76 g of a photopolymerization initiator (Irgacure 907 (trade name), produced by Ciba Specialty Chemicals Co., Ltd.), 301 g of methyl ethyl ketone and 9.0 g of cyclohexanone were mixed with stirring. The mixture was then filtered through a polypropylene filter having a pore diameter of 5 μm to prepare a low refractive layer coating solution D. The layer formed by the coating solution showed a refractive index of 1.44.

(Preparation of Low Refractive Layer Coating Solution D)

A low refractive layer coating solution D was prepared in the same manner as in the low refractive layer coating solution C, including the added amount, except that 1.95 g of a hollow silica sol (refractive index: 1.31; average particle diameter: 60 nm; solid content concentration: 20%) was used instead of silica sol. The layer formed by the coating solution showed a refractive index of 1.40.

(Preparation of Coating Solution for Low Refractive Layer E)

A low refractive layer coating solution E was prepared in the same manner as in the low refractive layer coating solution A, except for using JTA113 (solid content concentration: 6%; produced by JSR Co., Ltd.) instead of a heat-crosslinkable fluorine-containing polymer JN7228A. JTA113 is a heat-crosslinkable fluorine-containing polymer having a refractive index of 1.44 and a further improvement of scratch resistance from JN7228A. The layer formed by the coating solution showed a refractive index of 1.45.

### EXAMPLE 1

(1) Spreading of Light-Scattering Layer

The coating solution for light-scattering layer A was spread over a triacetyl cellulose film having a thickness of 80 μm (TAC-TD80UF”, produced by Fuji Photo Film Co., Ltd.) using a die coating method involving the use of the following device configuration under coating conditions. The coating layer was dried at 30° C. for 15 second and then at 90° C. for 20 second, and then irradiated with ultraviolet rays at an illuminance of 400 mW/cm² and a dose of 90 mJ/cm² using a 160 W/cm air-cooled metal halide lamp (produced by EYE GRAPHICS CO., LTD.) while the air in the system was being purged with nitrogen to undergo curing so that an anti-glare light-scattering layer was formed to a thickness of 6 μm. The film was then wound. Thus, Example 1-1 was effected.

Light-scattering layers were prepared in the same manner as mentioned above except that the light-scattering layer coating solution A was replaced by the light-scattering layer coating solutions B and C, respectively, and the wet spread was changed to 10 cc/m². These films were then wound. The film having the light-scattering layer coating solution B spread thereon was Comparative Example 1-1. The film having the light-scattering layer coating solution C spread thereon was Comparative Example 1-2.

Basic conditions: As the slot die 13 there was used one having an upstream lip land length I_{UP} of 0.5 mm, a downstream lip land length I_{LO} of 50 μm, a slot 16 opening length of 150 μm in the web running direction and a slot 16 length of 50 mm. The gap between the upstream lip land 18a and the web W was predetermined to be 50 μm longer than the gap between the downstream lip land 18b and the web W (hereinafter referred to as “overbite length of 50 μm”) and the gap G_{L} between the downstream lip land 18b and the web W was predetermined to be 50 μm. The gap G_{S} between the side plate 40b of the pressure reducing chamber 40 and the gap G_{B} between the back plate 40a and the web W were each predetermined to be 200 μm. Spreading was effected under conditions corresponding to the liquid physical properties of the respective coating solution. In some detail, the light-scattering layer coating solution was spread at a rate of 50 m/min to a wet spread of 17 ml/m². The low refractive layer coating solution was spread at a rate of 40 m/min to a wet spread of 5 ml/m². The coating width was 1,300 mm and the effective width was 1,280 mm.

(2) Spreading of Low Refractive Layer

The aforementioned low refractive layer coating solution A was spread over the triacetyl cellulose films having the light-scattering layer coating solutions A, B and C spread thereover, respectively, which were being unwound from a roll under the aforementioned basic conditions, and then dried at 120° C. for 150 seconds and then at 140° C. for 8 minutes. The coated films were each irradiated with ultraviolet rays at an illuminance of 400 mW/cm² and a dose of 900 mJ/cm² from a 240 W/cm air-cooled metal halide lamp in an atmosphere in which the air within had been purged with nitrogen so that the coating layer was cured to form a low refractive layer to a thickness of 100 nm. The films were each then wound.

(Saponification of Anti-Reflection Film)

The aforementioned sample 1 thus produced was then subjected to the following treatment.

There was prepared a 1.5 mol/l aqueous solution of sodium hydroxide which was then kept at 55° C. There was also prepared a 0.01 mol/l diluted aqueous solution of sulfuric acid which was then kept at 35° C. The anti-reflection film prepared above was dipped in the aforementioned aqueous solution of sodium hydroxide for 2 minutes, and then dipped in water so that the aqueous solution of sodium hydroxide was thoroughly washed away. Subsequently, the anti-reflection film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

Thus, saponified anti-reflection films were prepared as Example 1-3, Comparative Example 1-2 and Example 1-4, respectively.

(Evaluation of Light-Scattering Film)

The light-scattering films thus obtained were each then evaluated for the following properties. The results are set forth in Table 1.

(1) Average Reflectance

The film was roughened and then treated with a black ink on the back surface thereof. Having been thus rendered incapable of reflecting light on the back surface thereof, the film was then measured for spectral reflectance in the wavelength range of from 380 nm to 780 nm at an incidence angle of 5° on the front surface thereof using a spectrophotometer (produced by JASCO). The results were obtained by arithmetically averaging specular reflectance values in the wavelength range of from 450 to 650 nm.

(2) Dispersion of Light-Scattering Properties

A film having a width of 1,340 mm was cut into a length of 500 mm. The film thus sampled was then visually detected in transmission mode for crosswise dispersion of light-scattering properties. The results were then evaluated according to the following criterion.

| | |
|---|---|
| Dispersion is so extremely small that no unevenness can be visually | E |
| recognized: | |
| Dispersion is so small that little unevenness can be visually | G |
| recognized: | |
| Dispersion is so slightly large that unevenness can be visually | F |
| recognized: | |
| Dispersion is so large that unevenness can be visually at a glance: | P |

Samples of Examples 1-5 to 1-12 were prepared in the same manner as in Examples 1-3 (anti-reflection film having the light-scattering layer coating solution A and the low refractive layer coating solution A spread thereover) and 1-4 (anti-reflection film having the light-scattering layer coating solution C and the low refractive layer coating solution A spread thereover) except that the low refractive layer coating solution was changed to the low refractive layer coating solutions B to E, respectively. These samples were then evaluated in the same manner as in Examples 1-3 to 1-4. The results are set forth in Table 1. The coating solutions C and D for low refractive layer thus spread were each dried at 120° C. for 30 seconds, and then irradiated with ultraviolet rays having a luminous intensity of 400 mW/cm² at a dose of 900 mJ/cm² using a 240 W/cm air-cooled metal halide lamp (produced by EYE GRAPHICS CO., LTD.) while the air in the system was being purged with nitrogen to form low refractive layers.

TABLE 1

| | Light- | | Low | | Dispersion of | |
|---|---|---|---|---|---|---|
| | scattering | | refractive | % Average | light-scattering | |
| | layer | (σ − ρ) × d² | layer | reflectance | properties | Remarks |
| Example 1-1 | A | 0.86 | None | 4.5 | G | No precipitate |
| Comparative Example 1-1 | B | PMMA: 0.30 | None | 5.9 | P | Light-transmitting |
| | | Silica: 1.91 | | | | particulate material |
| | | | | | | precipitated in pocket and |
| | | | | | | manifold |
| Example 1-2 | C | 1.5 μm: 0.076 | None | 5.9 | E | No precipitate |
| | | 3.0 μm: 0.30 | | | | |
| Example 1-3 | A | 0.86 | A | 1.7 | G | No precipitate |
| Comparative Example 1-2 | B | PMMA: 0.30 | A | 1.6 | P | Light-transmitting |
| | | Silica: 1.91 | | | | particulate material |
| | | | | | | precipitated in pocket and |
| | | | | | | manifold |
| Example 1-4 | C | 1.5 μm: 0.076 | A | 1.6 | E | No precipitate |
| | | 3.0 μm: 0.30 | | | | |
| Example 1-5 | A | 0.86 | B | 1.2 | G | No precipitate |
| Example 1-6 | A | 0.86 | C | 1.8 | G | No precipitate |
| Example 1-7 | A | 0.86 | D | 1.4 | G | No precipitate |
| Example 1-8 | A | 0.86 | E | 1.9 | G | No precipitate |
| Example 1-9 | C | 1.5 μm: 0.076 | B | 1.0 | E | No precipitate |
| | | 3.0 μm: 0.30 | | | | |
| Example 1-10 | C | 1.5 μm: 0.076 | C | 1.7 | E | No precipitate |
| | | 3.0 μm: 0.30 | | | | |
| Example 1-11 | C | 1.5 μm: 0.076 | D | 1.2 | E | No precipitate |
| | | 3.0 μm: 0.30 | | | | |
| Example 1-12 | C | 1.5 μm: 0.076 | E | 1.8 | E | No precipitate |
| | | 3.0 μm: 0.30 | | | | |

The results set forth in Table 1 make the following facts obvious.

In accordance with the method of producing a light-scattering film of the invention, the rate of precipitation of the light-transmitting particulate material is controlled by satisfying the relationship (1). Therefore, the precipitation of light-transmitting particulate material in pocket, etc., which problem arises particularly when spreading is effected by a die coating method, doesn't occur. The resulting light-scattering film is excellent in uniformity in light-scattering properties in the plane of broad sample. Further, the die coating method of the invention is arranged to be fairly adapted to high speed coating particularly at a wet spread of 20 cc/cm² or less and thus provides a high productivity.

In Examples 1-1 to 1-12, as the diluting solvent to be used in the light-scattering layer coating solutions A and C there were used a 85/15 mixture of toluene and cyclohexanone and 70/30 mixture of toluene and cyclohexanone, respectively, instead of toluene. As a result, as the mixing proportion of cyclohexanone rose, the interfacial adhesion between the transparent support and the light-scattering layer increased and the scratch resistance of the film improved.

In Examples 1-1 to 1-12, the sol b was used instead of the sol a to be used in the low refractive layer coating solution. The resulting coating solution exhibited an enhanced age stability and hence a high adaptability to continuous coating.

To the low refractive layer coating solutions C and D was added 10 g of a mixture of dipentaerythritol pentaacrylate and dipentaerythritol hexaacrylate (DPHA, produced by NIPPON KAYAKU CO., LTD.). These coating solutions were then each spread in the same manner as mentioned above. The resulting light-scattering films exhibits a remarkably enhanced scratch resistance.

In Examples 1-1 to 1-12, as a thickening agent, acrylic polymer (molecular mass 75,000, produced by MITSUBISHI LAYON CO., LTD.) was added to coating solution A and cellulose acetate butylate (CAB-531-1, molecular mass 40,000, produced by EASTMAN CHEMICAL COMPANY) was added to coating solution C, so that the viscosity of each of the light-scattering layer coating solutions A and C becomes 7×10⁻³ Pa·s, then the coating solutions were thickened and coated. The gap G_{L} between the downstream lip land 18b and the web W was set to 40 μm. As a result, the sedimentation rate of the particulate material was further improved. And the sedimentation of the particulate material in a part of the solution sending piping after 24 h from the coating, which was found in the coating solution before the thickening, was not found, and the coating solutions turned out to be further superior in continuous production.

The thickening agents were further added, so that the viscosity of each of the light-scattering layer coating solutions A and C becomes 13 cp, as a result, it was found that the sedimentation rate of the particulate material in a rest state further slows, but the coating rate could be up to 30 m/min for the coating, thus the high speed coating aptitude was slightly inferior.

### EXAMPLE 2

A triacetyl cellulose film having a thickness of 80 μm (TAC-TD80U, produced by Fuji Photo Film Co., Ltd.) which had been dipped in a 1.5 mol/l aqueous solution of NaOH kept at 55° C. for 2 minutes, neutralized and rinsed and the light-scattering film (Examples 1-1 and 1-2) and anti-reflection film (saponified; Examples 1-3 to 1-12) prepared in Example 1 were bonded to the both sides of a polarizer prepared by adsorbing iodine to a polyvinyl alcohol which was then stretched to protect the polarizer. Thus, a polarizing plate was prepared. These polarizing plates were each used to prepare a transmission type TN liquid crystal display device having a light-scattering layer or anti-reflection layer disposed on the outermost layer thereof. These transmission type TN liquid crystal display devices caused no reflection of external light and thus exhibited an excellent viewability. In particular, the transmission type TN liquid crystal display devices having an anti-reflection film disposed therein caused less reflection of external light and thus exhibited an enhanced contrast and hence a better viewability.

### EXAMPLE 3

As each of the protective film to be disposed on the liquid crystal side of the polarizing plate on the viewing side and the protective film to be disposed on the liquid crystal side of the polarizing plate on the backlight side of the transmission type TN liquid crystal cell of Example 2 there was used a viewing angle widening film (Wide View Film SA 12B, produced by Fuji Photo Film Co., Ltd.). As a result, a liquid crystal display device having very wide horizontal and vertical viewing angles, an extremely excellent viewability and a high display quality was obtained.

Using a Type GP-5 goniophotoineter (produced by MURAKAMI COLOR RESEARCH LABORATORY), the film disposed perpendicular to incident light was then measured for scattered light profile in all the directions. From this profile was then determined the intensity of scattered light at an angle of 30° with respect to an emission angle of 0°. Examples 1-2, 1-4 and 1-9 to 1-12 (Samples comprising the light-scattering layer coating solution C) exhibited a scattered light intensity of 0.06% at an angle of 30° with respect to an emission angle of 0°. Since these samples had such light-scattering properties, the resulting liquid crystal display devices had a very good display quality, i.e., raised downward viewing angle and improved yellow tint in horizontal direction.

A 110 ppi high resolution cell was used as the transmission type TN liquid crystal cell of Example 2. As a result, those comprising the samples of Examples 1-1, 1-3 and 1-5 to 1-8 exhibited so high an adaptability to high resolution that little or no occurrence of so-called glittering attributed to uneven expansion/shrinkage of various pixels by the lens effect of anti-glare layer can be recognized.

### INDUSTRIAL APPLICABILITY

In accordance with the method of producing a light-scattering film of the invention, a coating composition containing a light-transmitting particulate material, a light-transmitting resin and a solvent which has been adjusted focusing on factors, i.e., density of the light-transmitting particulate material, density of the coating composition and average particle diameter of the light-transmitting particulate material such that the rate of sedimentation of the light-transmitting particulate material in the coating composition for light-scattering layer is not too high is spread over the surface of a transparent support using a die coating method, making it possible to produce a light-scattering film having no in-plane unevenness and uniform in-plane scattering properties even using a die coating method that attains a high productivity.

The entire disclosure of each and every foreign patent application from which the benefit of foreign priority has been claimed in the present application is incorporated herein by reference, as if fully set forth. horizontal and vertical viewing angle.

[Optical Compensation Layer]

The polarizing plate may comprise an optical compensation layer (retarder layer) incorporated therein to improve the viewing angle properties of a liquid crystal display screen.

As the optical compensation layer there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support.

This angle preferably changes with the rise of the distance from the transparent support side of the optically anisotropic layer composed of discotic compound.

In the case where the optical compensation layer is used as a protective film for polarizing film, the optical compensation layer is preferably saponified on the side thereof on which it is stuck to the polarizing film. The saponification of the optical compensation layer is preferably conducted in the same manner as mentioned above.

[Polarizing Film]

As the polarizing film there may be used a known polarizing film or a polarizing film cut out of a polarizing film of continuous length having an absorption axis which is neither parallel to nor perpendicular to the longitudinal direction. The polarizing film of continuous length having an absorption axis which is neither parallel to nor perpendicular to the longitudinal direction is prepared by the following method.

This is a polarizing film stretched by tensing a continuously supplied polymer while being retained at the both ends thereof by a retainer. In some detail, the polarizing film can be produced by a stretching method which comprises stretching the film by a factor of from 1.1 to 20.0 at least in the crosswise direction in such a mainer that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs [0020]-[0030].

[Image Display Device]

The light-scattering film prepared by the production method of the invention can be applied to image display devices such as liquid crystal display device (LCD), plasma display panel (PDP), electroluminescence (ELD), cathode ray tube display device (CRT), electric field emission display (FED) and surface electric field display (SED), particularly to liquid crystal display device (LCD).

<Image Display Device>

The light-scattering film or anti-reflection film prepared by the production method of the invention can be applied to image display devices such as liquid crystal display device (LCD), plasma display panel (PDP), electroluminescence (ELD), cathode ray tube display device (CRT), electric field emission display (FED) and surface electric field display (SED), particularly to liquid crystal display device (LCD).

<Liquid Crystal Display Device>

The anti-reflection film of the invention, if used as one of polarizing film surface protective films, is preferably used in transmission type, reflection type or semi-transmission type liquid crystal display devices of mode such as twisted nematic (TN), supertwisted nematic (STN), vertical alignment (VA), in-plane switching (IPS) and optically compensated bend cell (OCB).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high response.

In ECB mode liquid crystal cell, rod-shaped liquid crystal molecules are oriented substantially horizontal when no voltage is applied thereto. The ECB mode liquid crystal cell is used mostly as a color TFT liquid crystal display device. For details, reference can be made to many literatures, e.g., “EL, PDP, LCD Displays”, Toray Research Center, 2001.

For TV or IPS mode liquid crystal display devices in particular, the use of an optical compensation sheet having a viewing angle expanding effect as one of two sheets of polarizing film protective film opposite the anti-reflection film of the invention makes it possible to obtain a polarizing plate having both anti-reflection effect and viewing angle expanding effect by the thickness of only one sheet of polarizing plate as disclosed in JP-A-2001-100043.

### EXAMPLE

The invention will be further described in the following examples, but the invention is not limited thereto. The terms “parts” and “%” as used hereinafter are by mass unless otherwise specified.
(Synthesis of Perfluoroolefin Copolymer (1))

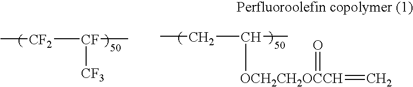

(The figure (50:50) indicates molar ratio)

In a 100 ml stainless steel autoclave with stirrer were charged 40 ml of ethyl acetate, 14.7 g of hydroxyethyl vinyl ether and 0.55 f of dilauroyl peroxide. The air in the system was evacuated and replaced by nitrogen gas. 25 g of hexafluoropropylene (HFP) was then introduced into the autoclave which was then heated to 65° C. The pressure in the autoclave developed when the temperature in the autoclave reached 65° C. was 0.53 MPa (5.4 kg/cm²). The temperature in the autoclave was then kept at 65° C. where the reaction was continued for 8 hours. When the pressure in the autoclave reached 0.31 MPa (3.2 kg/cm²), heating was suspended so that the autoclave was allowed to cool. When the internal temperature of the autoclave reached to room temperature, the unreacted monomers were then removed. The autoclave was then opened to withdraw the reaction solution. The reaction solution thus obtained was then poured into a large excess of hexane. By removing the solvent by decantation, the precipitated polymer was withdrawn. The polymer thus obtained was dissolved in a small amount of ethyl acetate. The solution was then twice reprecipitated from hexane to remove thoroughly the residual monomers. After dried, a polymer was obtained in an amount of 28 g. Subsequently, 20 g of the polymer thus obtained was dissolved in 100 ml of N,N-dimethylacetamide. To the solution was then added dropwise 11.4 g of acrylic acid chloride under ice cooling. The mixture was then stirred at room temperature for 10 hours. To the reaction solution was then added ethyl acetate. The reaction solution was then washed with water. The organic phase was then extracted. The residue was then concentrated. The polymer thus obtained was then reprecipitated from hexane to obtain 19 g of a perfluoroolefin copolymer (1) having the following structure which is a functional fluorine-containing polymer. The refractive index of the polymer thus obtained was 1.421.

(Preparation of Sol A)

Into a reaction vessel equipped with an agitator and a reflux condenser were charged 120 parts by mass of methyl ethyl ketone, 100 parts by mass of acryloyl oxypropyl trimethoxysilane “KBM-5103” (produced by Shin-Etsu Chemical Co., Ltd.) and 3 parts by mass of diisopropoxy aluminum ethyl acetoacetate. The mixture was then stirred. To the mixture were then added 30 parts by mass of deionized water. The reaction mixture was allowed to undergo reaction at 60° C. for 4 hours, and then allowed to cool to room temperature to obtain a sol a. The compound thus obtained had a mass-average molecular mass of 1,600. The proportion of components having a molecular mass of from 1,000 to 20,000 in the oligomer components or high components was 100%. The gas chromatography of the reaction product showed that none of the acryloyloxy propyl trimethoxysilane as raw material remained.

(Preparation of Sol B)

A sol b was obtained in the same manner as in the sol a except that the cooling of the reaction solution to room temperature was followed by the addition of 6 parts of acetyl acetone.

(Preparation of Coating Solution for Light-Scattering Layer A)

50 g of a mixture of pentaerythritol triacrylate and pentaerythritol tetraacrylate (PET-30, produced by NIPPON KAYAKU CO., LTD.) was diluted with 40 g of toluene. To the solution was then added 2 g of a photopolymerization initiator (Irgacure 184 (produced by Ciba Specialty Chemicals Co., Ltd.)). The mixture was then stirred. This solution was spread and dried, and then ultraviolet-cured to obtain a coating layer having a refractive index of 1.51.

To the solution were then added 1.7 g of a 30% toluene dispersion of crosslinked polystyrene particles having an average particle diameter of 3.5 μm (refractive index: 1.61; SX-350, produced by Soken Chemical & Engineering Co., Ltd.) which had been subjected to dispersion at 10,000 rpm using a polytron dispersing machine for 20 minutes and 13.3 g of a 30% toluene dispersion of crosslinked acryl-styrene particles having an average particle diameter of 3.5 μm (refractive index: 1.55; produced by Soken Chemical & Engineering Co., Ltd.). To the solution were then added 0.75 g of a fluorine-based surfactant (FP-149) and 10 g of a silane coupling agent (KBM-5103, produced by Shin-Etsu Chemical Co., Ltd.) to complete the desired solution.

The aforementioned mixture was then filtered through a polypropylene filter having a pore diameter of 30 μm to prepare a light-scattering layer coating solution A.

The liquid density of the coating solution was 0.99. The density of light-transmitting particulate material was 1.06. Accordingly, (σ−ρ)×d² was 0.86.

(Preparation of Coating Solution for Light-Scattering Layer B)

285 g of a commercially available zirconia-containing UV-curing hard coat solution (DeSolite Z7404, produced by JSR Co., Ltd.; solid content concentration: approx. 61%; ZrO2 content in solid content: approx. 70%; polymerizable monomer; polymerization initiator contained) and 85 g of a mixture of dipentaerythritol pentaacrylate and dipentaerythritol hexaacrylate (DPHA, produced by NIHON KAYAKU CO., LTD.) were mixed. The mixture was then diluted with 60 g of methyl isobutyl ketone and 17 g of methyl ethyl ketone. To the mixture was then added 28 g of a silane coupling agent (KBM-5103, produced by Shin-Etsu Chemical Co., Ltd.). The mixture was then stirred. The solution thus prepared was spread and dried, and then ultraviolet-cured to obtain a coating layer having a refractive index of 1.61.

To the solution was then added 34 g of a dispersion obtained by dispersing a 30% methyl isobutyl ketone dispersion of a classified reinforced crosslinked particulate PMMA having an average particle diameter of 3.0 μm (refractive index: 1.49; MXS-300, produced by Soken Chemical & Engineering Co., Ltd.) at 10,000 rpm by a polytron dispersing machine for 20 minutes. Subsequently, to the mixture were added 90 g of a dispersion obtained by dispersing a 30% methyl ethyl ketone dispersion of a particulate silica having an average particle diameter of 1.5 μm (refractive index: 1.46, SEAHOSTER KE-P150, produced by NIPPON SHOKUBAI CO., LTD.) at 10,000 rpm by a polytron dispersing machine for 30 minutes and finally 0.12 g of a fluorinated surfactant (FP-1). The mixture was then stirred to complete the desired solution.

The aforementioned mixture was filtered through a polypropylene filter having a pore diameter of 30 μm to prepare a light-scattering layer coating solution B.

The liquid density of the coating composition was 1.15. Referring to the density of the light-transmitting particulate material, the density of PMMA and silica were 1.18 and 2.0, respectively. However, PMMA swelled with the solvent in the coating composition to rise in the average particle diameter by about 30%. Thus, the apparent density of PMMA was 1.17. Accordingly, (σ−ρ)×d² was 0.30 for PMMA and 1.91 for silica.

(Preparation of Coating Solution for Light-Scattering Layer C)

A light-scattering layer coating solution C was prepared in the same manner as in the light-scattering layer coating solution B, including the added amount, except that 120 g of a 30% methyl ethyl ketone dispersion of a classified reinforced crosslinked particulate PMMA having an average particle diameter of 1.5 μm (MXS-150H; crosslinking agent; ethylene glycol dimethacrylate; amount of crosslinking agent: 30%; produced by Soken Chemical & Engineering Co., Ltd.; refractive index: 1.49) was used instead of the particulate silica having an average particle diameter of 1.5 μm.

The liquid density of the coating composition thus prepared was 1.15. The density of the light-transmitting particulate material was 1.18. However, since the light-transmitting particulate material swelled with the solvent in the coating composition to raise the average particle diameter thereof by about 30%, it showed an apparent density of 1.17. Accordingly, (σ−ρ)×d² was 0.076 for particulate material having a particle diameter of 1.5 μm and 0.30 for particulate material having a particle diameter of 3 μm.

(Preparation of Coating Solution for Low Refractive Layer A)

15 g of a heat-crosslinkable fluorine-containing polymer having a refractive index of 1.42 containing a polysiloxane and a hydroxyl group (JN7228A; solid content concentration: 6%; produced by JSR Co., Ltd.), 0.6 g of silica sol (silica; MEK-ST; average particle diameter: 15 nm; solid content concentration: 30%; produced by NISSAN CHEMICAL INDUSTRIES, LTD.), 0.8 g of silica sol (silica; same as MEK-ST except for particle size; average particle diameter: 45 nm; solid content concentration: 30%; produced by NISSAN CHEMICAL INDUSTRIES, LTD.), 0.4 g of sol a, 3 g of methyl ethyl ketone and 0.6 g of cyclohexanone were mixed with stirring. The mixture was then filtered through a polypropylene filter having a pore diameter of 1 μm to prepare a low refractive layer coating solution A. The layer formed by the coating solution showed a refractive index of 1.43.

(Preparation of Low Refractive Layer Coating Solution B)

A low refractive layer coating solution B was prepared in the same manner as in the low refractive layer coating solution A, including the added amount, except that 1.95 g of a hollow silica sol (refractive index: 1.31; average particle diameter: 60 nm; solid content concentration: 20%) was used instead of silica sol. The layer formed by the coating solution showed a refractive index of 1.38.

(Preparation of Coating Solution for Low Refractive Layer C)

15.2 g of a perfluoroolefin copolymer (1), 1.4 g of silica sol (silica; same as MEK-ST except for particle size; average particle diameter: 45 nm; solid content concentration: 30%; produced by NISSAN CHEMICAL INDUSTRIES, LTD.), 0.3 g of a reactive silicone X-22-164B (trade name: produced by Shin-Etsu Chemical Co., Ltd.), 7.3 g of sol a, 0.76 g of a photopolymerization initiator (Irgacure 907 (trade name), produced by Ciba Specialty Chemicals Co., Ltd.), 301 g of methyl ethyl ketone and 9.0 g of cyclohexanone were mixed with stirring. The mixture was then filtered through a polypropylene filter having a pore diameter of 5 μl to prepare a low refractive layer coating solution D. The layer formed by the coating solution showed a refractive index of 1.44.

(Preparation of Low Refractive Layer Coating Solution D)

A low refractive layer coating solution D was prepared in the same manner as in the low refractive layer coating solution C, including the added amount, except that 1.95 g of a hollow silica sol (refractive index: 1.31; average particle diameter: 60 nm; solid content concentration: 20%) was used instead of silica sol. The layer formed by the coating solution showed a refractive index of 1.40.

(Preparation of Coating Solution for Low Refractive Layer E)

A low refractive layer coating solution E was prepared in the same manner as in the low refractive layer coating solution A, except for using JTA113 (solid content concentration: 6%; produced by JSR Co., Ltd.) instead of a heat-crosslinkable fluorine-containing polymer JN7228A. JTA113 is a heat-crosslinkable fluorine-containing polymer having a refractive index of 1.44 and a further improvement of scratch resistance from JN7228A. The layer formed by the coating solution showed a refractive index of 1.45.

### EXAMPLE 1

### (1) Spreading of Light-Scattering Layer

The coating solution for light-scattering layer A was spread over a triacetyl cellulose film having a thickness of 80 μm (TAC-TD80UF”, produced by Fuji Photo Film Co., Ltd.) using a die coating method involving the use of the following device configuration under coating conditions. The coating layer was dried at 30° C. for 15 second and then at 90° C. for 20 second, and then irradiated with ultraviolet rays at an illuminance of 400 mW/cm² and a dose of 90 mJ/cm² using a 160 W/cm air-cooled metal halide lamp (produced by EYE GRAPHICS CO., LTD.) while the air in the system was being purged with nitrogen to undergo curing so that an anti-glare light-scattering layer was formed to a thickness of 6 μm. The film was then wound. Thus, Example 1-1 was effected.

Light-scattering layers were prepared in the same manner as mentioned above except that the light-scattering layer coating solution A was replaced by the light-scattering layer coating solutions B and C, respectively, and the wet spread was changed to 10 cc/m². These films were then wound. The film having the light-scattering layer coating solution B spread thereon was Comparative Example 1-1. The film having the light-scattering layer coating solution C spread thereon was Comparative Example 1-2.

Basic conditions: As the slot die 13 there was used one having an upstream lip land length I_{UP} of 0.5 mm, a downstream lip land length I_{LO} of 50 μm, a slot 16 opening length of 150 μm in the web running direction and a slot 16 length of 50 mm. The gap between the upstream lip land 18a and the web W was predetermined to be 50 μm longer than the gap between the downstream lip land 18b and the web W (hereinafter referred to as “overbite length of 50 μm”) and the gap G_{L} between the downstream lip land 18b and the web W was predetermined to be 50 μm. The gap G_{S} between the side plate 40b of the pressure reducing chamber 40 and the gap G_{B} between the back plate 40a and the web W were each predetermined to be 200 μm. Spreading was effected under conditions corresponding to the liquid physical properties of the respective coating solution. In some detail, the light-scattering layer coating solution was spread at a rate of 50 m/min to a wet spread of 17 ml/m². The low refractive layer coating solution was spread at a rate of 40 m/min to a wet spread of 5 ml/m². The coating width was 1,300 mm and the effective width was 1,280 mm.

(2) Spreading of Low Refractive Layer

The aforementioned low refractive layer coating solution A was spread over the triacetyl cellulose films having the light-scattering layer coating solutions A, B and C spread thereover, respectively, which were being unwound from a roll under the aforementioned basic conditions, and then dried at 120° C. for 150 seconds and then at 140° C. for 8 minutes. The coated films were each irradiated with ultraviolet rays at an illuminance of 400 mW/cm² and a dose of 900 mJ/cm² from a 240 W/cm air-cooled metal halide lamp in an atmosphere in which the air within had been purged with nitrogen so that the coating layer was cured to form a low refractive layer to a thickness of 100 nm. The films were each then wound.

(Saponification of Anti-Reflection Film)

The aforementioned sample 1 thus produced was then subjected to the following treatment.

There was prepared a 1.5 mol/l aqueous solution of sodium hydroxide which was then kept at 55° C. There was also prepared a 0.01 mol/l diluted aqueous solution of sulfuric acid which was then kept at 35° C. The anti-reflection film prepared above was dipped in the aforementioned aqueous solution of sodium hydroxide for 2 minutes, and then dipped in water so that the aqueous solution of sodium hydroxide was thoroughly washed away. Subsequently, the anti-reflection film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

Thus, saponified anti-reflection films were prepared as Example 1-3, Comparative Example 1-2 and Example 1-4, respectively.

(Evaluation of Light-Scattering Film)

The light-scattering films thus obtained were each then evaluated for the following properties. The results are set forth in Table 1.

(1) Average Reflectance

The film was roughened and then treated with a black ink on the back surface thereof. Having been thus rendered incapable of reflecting light on the back surface thereof, the film was then measured for spectral reflectance in the wavelength range of from 380 nm to 780 nm at an incidence angle of 5° on the front surface thereof using a spectrophotometer (produced by JASCO). The results were obtained by arithmetically averaging specular reflectance values in the wavelength range of from 450 to 650 nm.

(2) Dispersion of Light-Scattering Properties

A film having a width of 1,340 mm was cut into a length of 500 mm. The film thus sampled was then visually detected in transmission mode for crosswise dispersion of light-scattering properties. The results were then evaluated according to the following criterion.

| | |
|---|---|
| Dispersion is so extremely small that no unevenness can be visually | E |
| recognized: | |
| Dispersion is so small that little unevenness can be visually | G |
| recognized: | |
| Dispersion is so slightly large that unevenness can be visually | F |
| recognized: | |
| Dispersion is so large that unevenness can be visually at a glance: | P |

Samples of Examples 1-5 to 1-12 were prepared in the same manner as in Examples 1-3 (anti-reflection film having the light-scattering layer coating solution A and the low refractive layer coating solution A spread thereover) and 1-4 (anti-reflection film having the light-scattering layer coating solution C and the low refractive layer coating solution A spread thereover) except that the low refractive layer coating solution was changed to the low refractive layer coating solutions B to E, respectively. These samples were then evaluated in the same manner as in Examples 1-3 to 1-4. The results are set forth in Table 1. The coating solutions C and D for low refractive layer thus spread were each dried at 120° C. for 30 seconds, and then irradiated with ultraviolet rays having a luminous intensity of 400 mW/cm² at a dose of 900 mJ/cm² using a 240 W/cm air-cooled metal halide lamp (produced by EYE GRAPHICS CO., LTD.) while the air in the system was being purged with nitrogen to form low refractive layers.

TABLE 1

| | Light- | | Low | | Dispersion of | |
|---|---|---|---|---|---|---|
| | scattering | | refractive | % Average | light-scattering | |
| | layer | (σ − ρ) × d² | layer | reflectance | properties | Remarks |
| Example 1-1 | A | 0.86 | None | 4.5 | G | No precipitate |
| Comparative Example 1-1 | B | PMMA: 0.30 | None | 5.9 | P | Light-transmitting |
| | | Silica: 1.91 | | | | particulate material |
| | | | | | | precipitated in pocket and |
| | | | | | | manifold |
| Example 1-2 | C | 1.5 μm: 0.076 | None | 5.9 | E | No precipitate |
| | | 3.0 μm: 0.30 | | | | |
| Example 1-3 | A | 0.86 | A | 1.7 | G | No precipitate |
| Comparative Example 1-2 | B | PMMA: 0.30 | A | 1.6 | P | Light-transmitting |
| | | Silica: 1.91 | | | | particulate material |
| | | | | | | precipitated in pocket and |
| | | | | | | manifold |
| Example 1-4 | C | 1.5 μm: 0.076 | A | 1.6 | E | No precipitate |
| | | 3.0 μm: 0.30 | | | | |
| Example 1-5 | A | 0.86 | B | 1.2 | G | No precipitate |
| Example 1-6 | A | 0.86 | C | 1.8 | G | No precipitate |
| Example 1-7 | A | 0.86 | D | 1.4 | G | No precipitate |
| Example 1-8 | A | 0.86 | E | 1.9 | G | No precipitate |
| Example 1-9 | C | 1.5 μm: 0.076 | B | 1.0 | E | No precipitate |
| | | 3.0 μm: 0.30 | | | | |
| Example 1-10 | C | 1.5 μm: 0.076 | C | 1.7 | E | No precipitate |
| | | 3.0 μm: 0.30 | | | | |
| Example 1-11 | C | 1.5 μm: 0.076 | D | 1.2 | E | No precipitate |
| | | 3.0 μm: 0.30 | | | | |
| Example 1-12 | C | 1.5 μm: 0.076 | E | 1.8 | E | No precipitate |
| | | 3.0 μm: 0.30 | | | | |

The results set forth in Table 1 make the following facts obvious.

In accordance with the method of producing a light-scattering film of the invention, the rate of precipitation of the light-transmitting particulate material is controlled by satisfying the relationship (1). Therefore, the precipitation of light-transmitting particulate material in pocket, etc., which problem arises particularly when spreading is effected by a die coating method, doesn't occur. The resulting light-scattering film is excellent in uniformity in light-scattering properties in the plane of broad sample. Further, the die coating method of the invention is arranged to be fairly adapted to high speed coating particularly at a wet spread of 20 cc/cm² or less and thus provides a high productivity.

In Examples 1-1 to 1-12, as the diluting solvent to be used in the light-scattering layer coating solutions A and C there were used a 85/15 mixture of toluene and cyclohexanone and 70/30 mixture of toluene and cyclohexanone, respectively, instead of toluene. As a result, as the mixing proportion of cyclohexanone rose, the interfacial adhesion between the transparent support and the light-scattering layer increased and the scratch resistance of the film improved.

In Examples 1-1 to 1-12, the sol b was used instead of the sol a to be used in the low refractive layer coating solution. The resulting coating solution exhibited an enhanced age stability and hence a high adaptability to continuous coating.

To the low refractive layer coating solutions C and D was added 10 g of a mixture of dipentaerythritol pentaacrylate and dipentaerythritol hexaacrylate (DPHA, produced by NIPPON KAYAKU CO., LTD.). These coating solutions were then each spread in the same manner as mentioned above. The resulting light-scattering films exhibits a remarkably enhanced scratch resistance.

In Examples 1-1 to 1-12, as a thickening agent, acrylic polymer (molecular mass 75,000, produced by MITSUBISHI LAYON CO., LTD.) was added to coating solution A and cellulose acetate butylate (CAB-531-1, molecular mass 40,000, produced by EASTMAN CHEMICAL COMPANY) was added to coating solution C, so that the viscosity of each of the light-scattering layer coating solutions A and C becomes 7×10⁻³ Pa·s, then the coating solutions were thickened and coated. The gap G_{L} between the downstream lip land 18b and the web W was set to 40 μm. As a result, the sedimentation rate of the particulate material was further improved. And the sedimentation of the particulate material in a part of the solution sending piping after 24 h from the coating, which was found in the coating solution before the thickening, was not found, and the coating solutions turned out to be further superior in continuous production.

The thickening agents were further added, so that the viscosity of each of the light-scattering layer coating solutions A and C becomes 13 cp, as a result, it was found that the sedimentation rate of the particulate material in a rest state further slows, but the coating rate could be up to 30 m/min for the coating, thus the high speed coating aptitude was slightly inferior.

### EXAMPLE 2

A triacetyl cellulose film having a thickness of 80 μm (TAC-TD80U, produced by Fuji Photo Film Co., Ltd.) which had been dipped in a 1.5 mol/l aqueous solution of NaOH kept at 55° C. for 2 minutes, neutralized and rinsed and the light-scattering film (Examples 1-1 and 1-2) and anti-reflection film (saponified; Examples 1-3 to 1-12) prepared in Example 1 were bonded to the both sides of a polarizer prepared by adsorbing iodine to a polyvinyl alcohol which was then stretched to protect the polarizer. Thus, a polarizing plate was prepared. These polarizing plates were each used to prepare a transmission type TN liquid crystal display device having a light-scattering layer or anti-reflection layer disposed on the outermost layer thereof. These transmission type TN liquid crystal display devices caused no reflection of external light and thus exhibited an excellent viewability. In particular, the transmission type TN liquid crystal display devices having an anti-reflection film disposed therein caused less reflection of external light and thus exhibited an enhanced contrast and hence a better viewability.

### EXAMPLE 3

As each of the protective film to be disposed on the liquid crystal side of the polarizing plate on the viewing side and the protective film to be disposed on the liquid crystal side of the polarizing plate on the backlight side of the transmission type TN liquid crystal cell of Example 2 there was used a viewing angle widening film (Wide View Film SA 12B, produced by Fuji Photo Film Co., Ltd.). As a result, a liquid crystal display device having very wide horizontal and vertical viewing angles, an extremely excellent viewability and a high display quality was obtained.

Using a Type GP-5 goniophotometer (produced by MURAKAMI COLOR RESEARCH LABORATORY), the film disposed perpendicular to incident light was then measured for scattered light profile in all the directions. From this profile was then determined the intensity of scattered light at an angle of 30° with respect to an emission angle of 0°. Examples 1-2, 1-4 and 1-9 to 1-12 (Samples comprising the light-scattering layer coating solution C) exhibited a scattered light intensity of 0.06% at an angle of 30° with respect to an emission angle of 0°. Since these samples had such light-scattering properties, the resulting liquid crystal display devices had a very good display quality, i.e., raised downward viewing angle and improved yellow tint in horizontal direction.

A 110 ppi high resolution cell was used as the transmission type TN liquid crystal cell of Example 2. As a result, those comprising the samples of Examples 1-1, 1-3 and 1-5 to 1-8 exhibited so high an adaptability to high resolution that little or no occurrence of so-called glittering attributed to uneven expansion/shrinkage of various pixels by the lens effect of anti-glare layer can be recognized.

### INDUSTRIAL APPLICABILITY

In accordance with the method of producing a light-scattering film of the invention, a coating composition containing a light-transmitting particulate material, a light-transmitting resin and a solvent which has been adjusted focusing on factors, i.e., density of the light-transmitting particulate material, density of the coating composition and average particle diameter of the light-transmitting particulate material such that the rate of sedimentation of the light-transmitting particulate material in the coating composition for light-scattering layer is not too high is spread over the surface of a transparent support using a die coating method, making it possible to produce a light-scattering film having no in-plane unevenness and uniform in-plane scattering properties even using a die coating method that attains a high productivity.

The entire disclosure of each and every foreign patent application from which the benefit of foreign priority has been claimed in the present application is incorporated herein by reference, as if fully set forth.

1. A method of producing a light-scattering film comprising a light-scattering layer provided directly or indirectly on a transparent support, the method comprising:
disposing a land of a forward end lip of a slot die close to a surface of a web; and
applying a coating composition for the light-scattering layer on the web through a slot of the forward end lip, so as to provide the coating composition for the light-scattering layer directly or indirectly on the transparent support,
wherein the web is being continuously running while being supported on a backup roll, and
wherein the coating composition comprises a light-transmitting particulate material, a transmitting resin and a solvent, and the coating composition satisfies relationship (1) in order to control a sedimentation rate of the light-transmitting particulate material:
(σ−ρ)×d²≦1.5 (1)
wherein σ represents a density of the light-transmitting particulate material (g/cm²);
ρ represents a density of the coating composition (g/cm²); and
d represents an average particle diameter of the light-transmitting particulate material (μm).

2. The method of producing a light-scattering film according to claim 1,
wherein the light-transmitting particulate material in the coating composition swells with the solvent to allow σ, ρ and d after swelling to satisfy the relationship (1).

3. The method of producing a light-scattering film according to claim 1,
wherein an average particle diameter of the light-transmitting particulate material is from 0.5 μm to 5 μm, a difference in refractive index between the light-transmitting particulate material and the light-transmitting resin is from 0.01 to 0.2 and an amount of the light-transmitting particulate material in the light-scattering layer is from 3 to 30% by mass based on a total solid content in the light-scattering layer.

4. The method of producing a light-scattering film according to claim 1,
wherein the light-transmitting particulate material is a crosslinked polystyrene, a crosslinked poly(acryl-styrene), a crosslinked poly((meth)acrylate) or a mixture thereof, and the solvent comprises at least one solvent selected from the group consisting of a ketone, toluene, xylene and an ester.

5. The method of producing a light-scattering film according to claim 1,
wherein the light-scattering film is an anti-reflection film comprising a low refractive layer having a lower refractive index than a refractive index of the transparent support, and the low refractive layer is formed directly on the light-scattering layer or on a layer(s) provided on the light-scattering layer.

6. The method of producing a light-scattering film according to claim 1, which further comprises applying a coating composition for the low refractive layer or a coating composition for an other layer on the web by utilizing a slot die having an overbite form,
wherein the slot die comprises a downstream lip having a land length of not smaller than 30 μm to not greater than 100 μm and an upstream lip, and
wherein a gap between the downstream lip and the web is smaller than a gap between the upstream lip and the web by from not smaller than 30 μm to not greater than 120 μm when the slot die is disposed at a coating position.

7. A polarizing plate comprising:
a polarizing film; and
two sheets of protective films, and each one of the protective films is laminated on a front surface or a back surface of the polarizing film respectively, for protecting both the front surface and the back surface of the polarizing film,
wherein a light-scattering film produced by a method according to claim 1 is utilized as one of the protective films.

8. The polarizing plate according to claim 7,
wherein a film other than the light-scattering film among the two sheets of the protective films constituting the polarizing plate is an optical compensation film comprising an optical compensation layer containing an optically anisotropic layer provided on a side opposite to a side on which the film is laminated on the polarizing film, the optically anisotropic layer is a layer comprising a compound having a discotic structure unit, a disc surface of the discotic structure unit is disposed obliquely to a surface of the protective film and an angle of the disc surface of the discotic structure unit with respect to the surface of the protective film changes in a depth direction of the optically anisotropic layer.

9. An image display device comprising a light-scattering film produced by a method according to claim 1.

10. A liquid crystal display device comprising at least one of a light-scattering film produced by a method according to claim 1.

11. A liquid crystal display device comprising:
a liquid crystal cell;
a polarizer provided on both sides of the liquid crystal cell;
at least one sheet of a phase difference compensating element provided between the liquid crystal cell and the polarizer; and
a light-scattering film produced by a method according to claim 1 provided on a surface of the liquid crystal display device.
